(19) United States
(12) Patent Application Publication
(10) Pub. No.: US 2025/0045700 A1
(43) Pub. Date: Feb. 6, 2025

(54) MULTI-TIER MULTIMEDIA EMPLOYMENT DISTRIBUTION HUB

(71) Applicant: PEOZZLE Corporation, Plymouth, MN (US)

(72) Inventor: Edward Chavan, Plymouth, MN (US)

(73) Assignee: PEOZZLE Corporation, Plymouth, MN (US)

(21) Appl. No.: 18/607,412

(22) Filed: Mar. 15, 2024

Related U.S. Application Data
(60) Provisional application No. 63/452,435, filed on Mar. 15, 2023.
(60) Provisional application No. 63/611,115, filed on Dec. 15, 2023.

(51) Int. Cl. G06Q 10/1053; H04L 9/40

(52) U.S. Cl. CPC G06Q 10/1053; H04L 63/105

(57) ABSTRACT

A multi-tier multimedia employment distribution hub system includes a tier-1 multimedia employment distribution hub including a group of tier-1employment hub appliances including processors and memory configured to store and execute a group of tier-1 employment hub applications to grant access privilege to the tier-1 multimedia employment distribution hub, the access privilege granted to roles in tier-1 employment client systems, tier-1 employment server systems, and tier-1 employment core systems; and control the tier-1 employment client systems, the tier-1 employment server systems, and the tier-1 employment core systems.

### CROSS REFERENCE TO RELATED APPLICATIONS

This Non-Provisional patent application claims the benefit of both the filing dates of U.S. Provisional Patent Application Ser. No. 63/452,435, filed Mar. 15, 2023, entitled “MULTI-TIER MULTIMEDIA EMPLOYMENT DISTRIBUTION HUB,” and of U.S. Provisional Patent Application Ser. No. 63/611,115, filed Dec. 15, 2023, entitled “MULTI-TIER MULTIMEDIA EMPLOYMENT DISTRIBUTION HUB,” the entire teachings of which are incorporated herein by reference.

This application is also related to U.S. patent application Ser. No. 15/014,000, filed Feb. 2, 2016, entitled “MULTIMEDIA HUMAN RESOURCE DISTRIBUTION SYSTEM,” having Attorney Docket No. P1476.101.103, now U.S. Pat. No. 11,107,039, U.S. patent application Ser. No. 15/013,998, filed Feb. 2, 2016, entitled “MULTIMEDIA HUMAN RESOURCE DISTRIBUTION SYSTEM,” having Attorney Docket No. P1476.101.102, now U.S. Pat. No. 11,107,038, both of which claim the benefit of the filing date of U.S. Provisional Patent Application Ser. No. 62/111,552, filed Feb. 3, 2015, entitled “MULTIMEDIA RESUME DISTRIBUTION SYSTEM” having Attorney Docket No. P1476.101.101, which are herein incorporated by reference.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a diagram of an example of a tier-1 multimedia employment distribution hub.

FIG. 2 is a diagram of an example of a tier-2 multimedia employment distribution hub.

FIG. 3 is a diagram of an example of a tier-3 multimedia employment distribution hub.

FIG. 4 is a diagram of an example of a tier-4 multimedia employment distribution hub.

FIG. 5 is a diagram of an example of a tier-n multimedia employment distribution hub.

FIG. 6 is a diagram illustrating an example multimedia employment distribution hub tier-1 system architecture for building a tier-1 multimedia employment distribution hub.

FIG. 7 is a diagram of an example multimedia employment distribution hub tier-1 solution architecture illustrating example roles that will be granted access privilege to a tier-1 multimedia employment distribution hub.

FIG. 8 is a diagram of an example multimedia employment distribution hub tier-1 hardware architecture illustrating a hardware based infrastructure, which includes special purpose hardware components of a tier-1 multimedia employment distribution hub.

FIG. 9 is a diagram of an example multimedia employment distribution hub tier-1 software architecture illustrating a software application solution, which includes special purpose Software components of a tier-1 multimedia employment distribution hub.

FIG. 10 is a diagram of an example multimedia employment distribution hub tier-2 hardware architecture illustrating a hardware based infrastructure solution, which includes special purpose hardware components of a tier-2 multimedia employment distribution hub.

FIG. 11 is a diagram of an example multimedia employment distribution hub tier-2 software architecture illustrating a software application solution, which includes special purpose Software components of a tier-2 multimedia employment distribution hub.

FIG. 12A is a diagram of an example multimedia employment distribution hub tier-3 granular-A hardware architecture illustrating a hardware based infrastructure solution, which includes special purpose hardware components of a tier-3 multimedia employment distribution hub.

FIG. 12B is a diagram of an example multimedia employment distribution hub tier-3 granular-B hardware architecture illustrating a hardware based infrastructure solution, which includes special purpose hardware components of a tier-3 multimedia employment distribution hub.

FIG. 12C is a diagram of an example multimedia employment distribution hub tier-3 hardware granular-C architecture illustrating a hardware based infrastructure solution, which includes special purpose hardware components of a tier-3 multimedia employment distribution hub.

FIG. 12D is a diagram of an example multimedia employment distribution hub tier-3 granular-D hardware architecture illustrating a hardware based infrastructure solution, which includes special purpose hardware components of a tier-3 multimedia employment distribution hub.

FIG. 13 is a diagram of an example multimedia employment distribution hub tier-3 software architecture illustrating a software application solution, which includes special purpose Software components of a tier-3 multimedia employment distribution hub.

FIG. 14A is a diagram of an example multimedia employment distribution hub tier-3 granular-A software architecture illustrating a software application solution, which includes special purpose Software components of a tier-3 multimedia employment distribution hub.

FIG. 14B is a diagram of an example multimedia employment distribution hub tier-3 granular-B software architecture illustrating a software application solution, which includes special purpose Software components of a tier-3 multimedia employment distribution hub.

FIG. 14C is a diagram of an example multimedia employment distribution hub tier-3 granular-C software architecture illustrating a software application solution, which includes special purpose Software components of a tier-3 multimedia employment distribution hub.

FIG. 14D is a diagram of an example multimedia employment distribution hub tier-3 granular-N software architecture illustrating a software application solution, which includes special purpose Software components of a tier-3 multimedia employment distribution hub.

FIG. 15 is a diagram of an example multimedia employment distribution hardware architecture Before illustrating a hardware based employment infrastructure Before solution, which includes special purpose hardware components of a multimedia employment distribution system Before.

FIG. 16 is a diagram of an example multimedia employment distribution hardware architecture After illustrating a hardware based employment infrastructure After solution, which includes special purpose hardware components of a multimedia employment distribution system After.

FIG. 17 is a diagram of an example multimedia employment distribution software architecture Before illustrating a software application Before solution, which includes special purpose software components of a multimedia employment distribution system Before.

FIG. 18 is a diagram of an example multimedia employment distribution software architecture After illustrating a software application After solution, which includes special purpose software components of a multimedia employment distribution system After.

FIG. 19 is a flow diagram illustrating an example method for software core to record multimedia content.

FIG. 20 is a flow diagram illustrating an example method for software core to record multimedia content. This is a continuation of FIG. 19.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In the following Detailed Description, reference is made to the accompanying drawings, which form a part hereof, and in which is shown by way of illustration specific embodiments in which the invention may be practiced. Because components of embodiments can be positioned in a number of different orientations, directional terminology is used for purposes of illustration and is in no way limiting. It is to be understood that other embodiments may be utilized and structural or logical changes may be made without departing from the scope of the present invention.

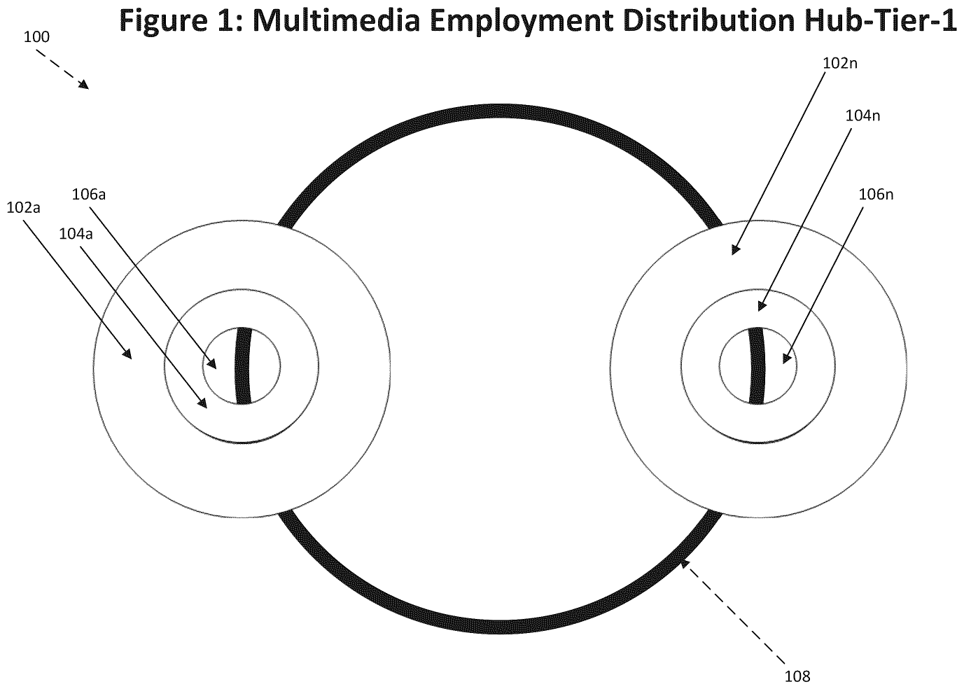

FIG. 1 illustrates an example of a tier-1 multimedia employment distribution hub. Tier-1 multimedia employment distribution hub 100 includes: employment client systems 102a-102n; employment server systems 104a-104n; employment core systems 106a-106n; tier-1 employment hub 108.

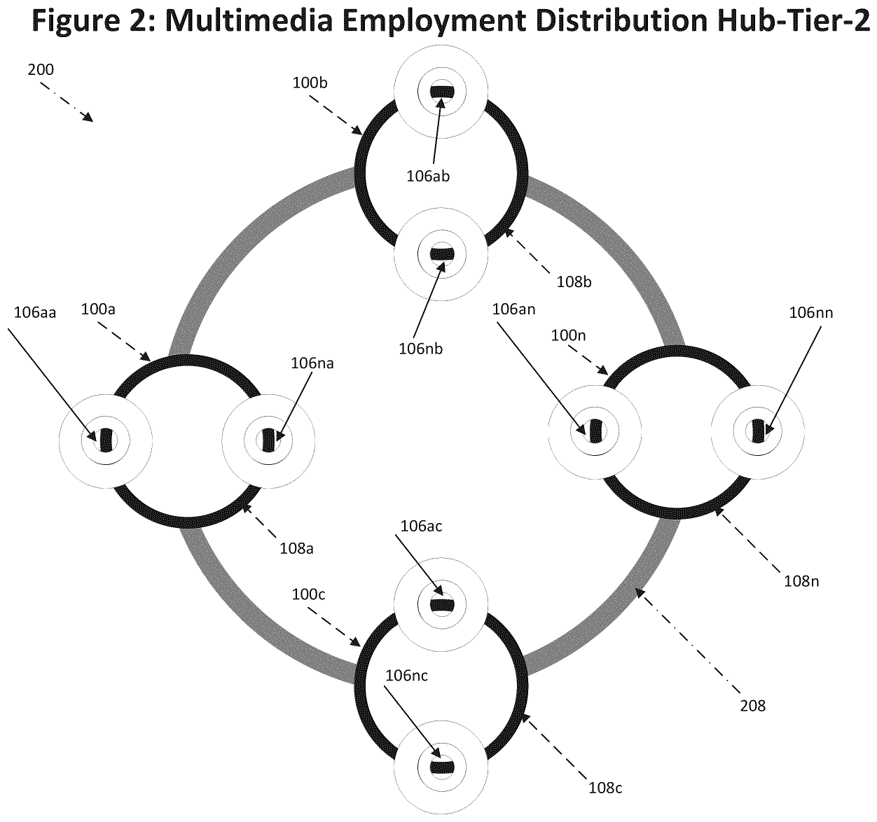

FIG. 2 illustrates an example of a tier-2 multimedia employment distribution hub. Tier-2 multimedia employment distribution hub 200 includes: tier-1 multimedia employment distribution hubs 100a-100n; employment core systems 106aa-106nn; tier-1 employment hubs 108a-108n; tier-2 employment hub 208.

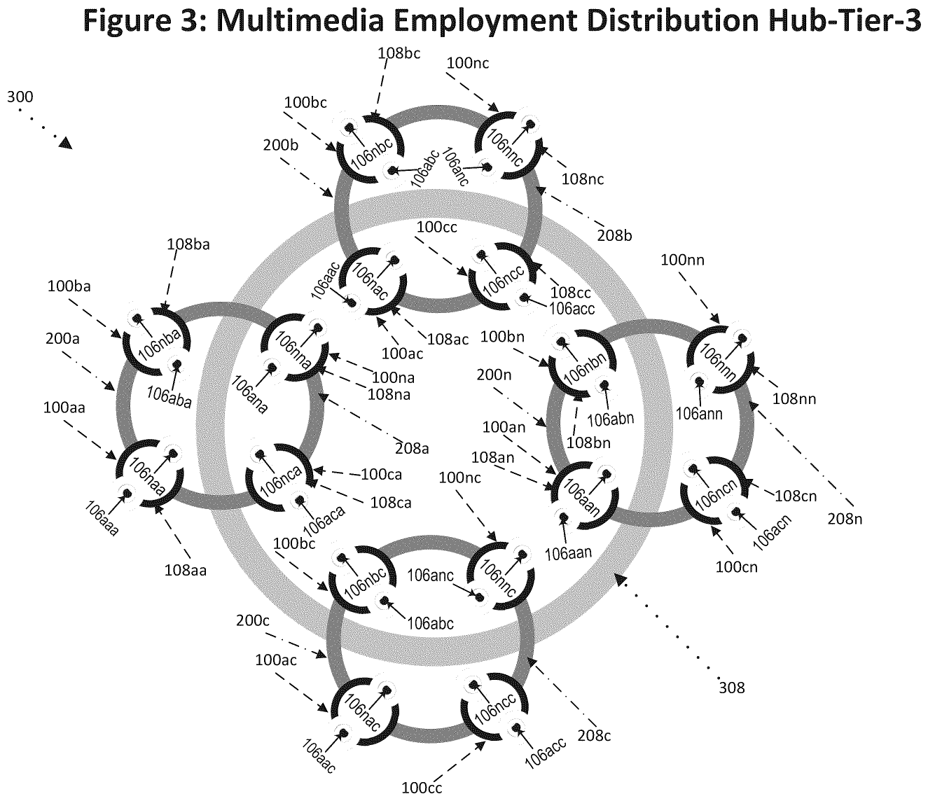

FIG. 3 illustrates an example of a tier-3 multimedia employment distribution hub. Tier-3 multimedia employment distribution hub 300 includes: tier-2 multimedia employment distribution hubs 200a-200n; tier-1 multimedia employment distribution hubs 100aa-100nn; employment core systems 106aaa-106nnn; tier-1 employment hubs 108aa-108nn; tier-2 employment hub 208a-208n; tier-3 employment hub 308.

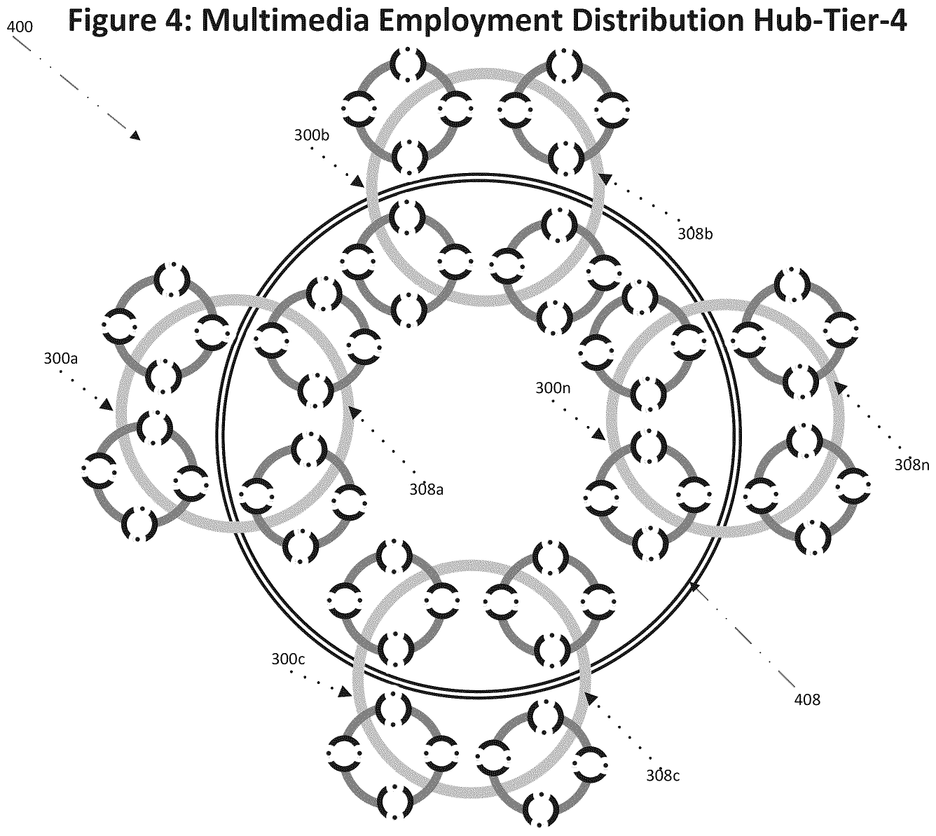

FIG. 4 illustrates an example of a tier-4 multimedia employment distribution hub. Tier-4 multimedia employment distribution hub 400 includes: tier-3 multimedia employment distribution hubs 300a-300n; tier-3 employment hubs 308a-308n; tier-4 employment hub 408.

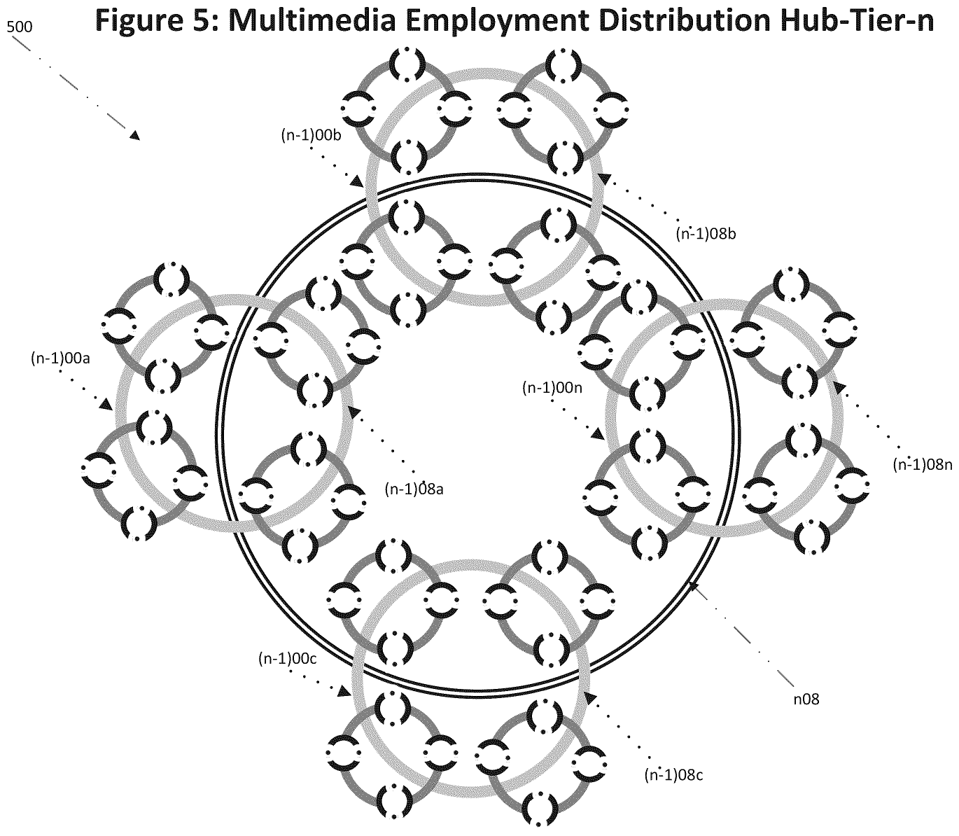

FIG. 5 illustrates an example of a tier-n multimedia employment distribution hub. Tier-n multimedia employment distribution hub 500 includes: tier-(n−1) multimedia employment distribution hubs (n−1)00a-(n−1)00n; tier-3 employment hub(n−1)00a-(n−1) 00n; tier-n employment hub n08.

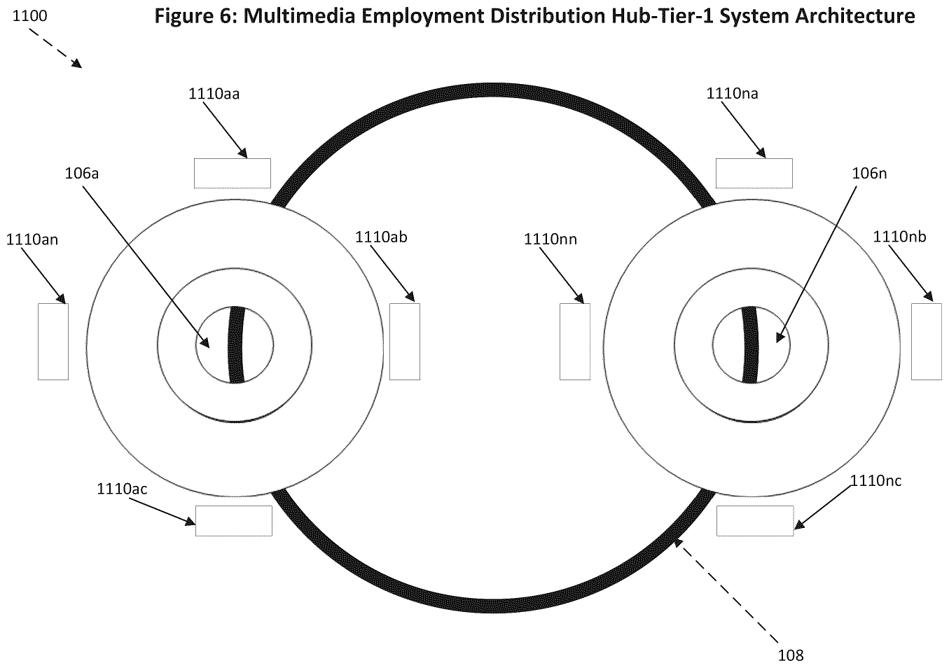

FIG. 6 illustrates an example of a tier-1 multimedia employment distribution hub system architecture. Tier-1 multimedia employment distribution hub system architecture 1100 includes: hiring teams 1110aa-1110na; a group of candidates 1110ab-1110nb; a group of third-party service providers (including career boards, social media channels, credential verifiers, employment verifiers, candidate backpacks, etc.,) 1110ac-1110nc; a group of staffing, human resources, and placement teams 1110an-1110nn; a group of Staffing core systems 106a-106n; tier-1 employment hub 108.

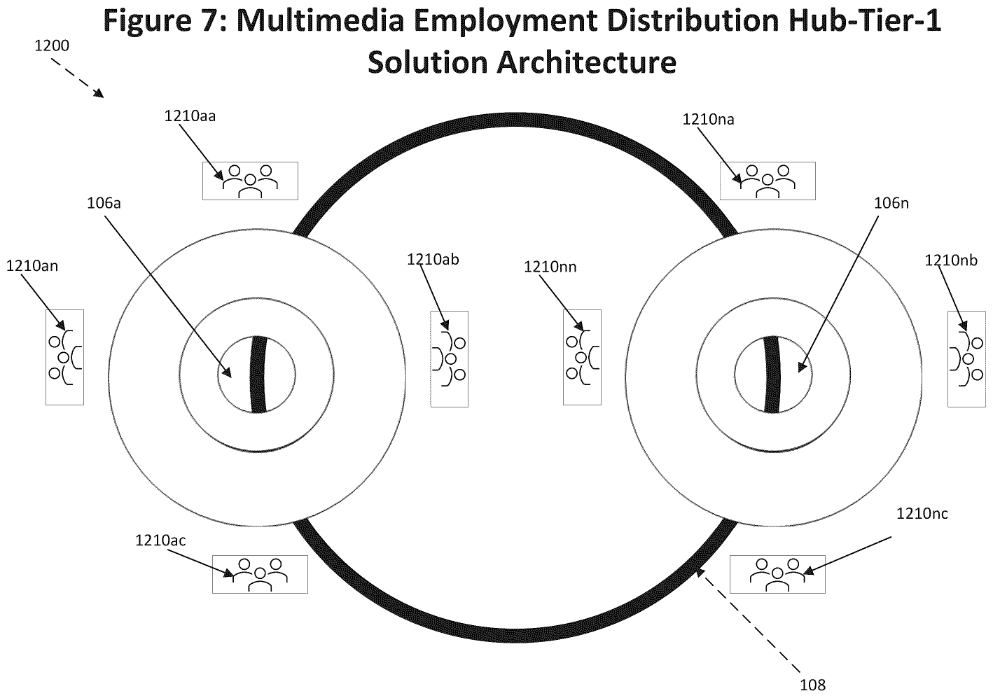

FIG. 7 illustrates an example of a tier-1 multimedia employment distribution hub system architecture 1200 illustrating example roles that will be granted access privilege to a tier-1 multimedia employment distribution hub system. Roles that will be granted access privilege to the tier-1 multimedia employment distribution hub system include an example hiring teams 1110aa-1110na including a hiring screener role, a hiring manager role, and a hiring interviewer role. In some scenarios, a single user may play more than one role at any time.

FIG. 7 illustrates group of job seekers (such as, candidates, gig workers, students, interns, and volunteers, etc.,) 1210ab-1210nb. There can be any number of job seekers. Example job seekers include legal assistant, software consultant, office administrator, and any other suitable job candidates. In some scenarios, a single user may play more than one role at any time.

FIG. 7 illustrates group of third party service provider roles 1210ac-1210nc. There can be any number of third party service provider roles. Example third party service provider roles 1210ac-1210nc include career boards, social media channels, credential verifiers, employment verifiers, candidate backpack services, sub-contracting service provider, personality test provider, drug test provider, aptitude test provider, background check provider, and any other suitable third party service provider role. In some scenarios, a single user may play more than one role at any time.

FIG. 7 illustrates staffing team roles 1210an-1210nn including a group of staffing recruiter roles, a group of staffing account manager roles, a group of staffing manager roles, a group of human resources recruiter roles, a group of human resources manager roles, a group of placement officer roles, a group of placement manager roles, a group of placement director roles, a group of volunteer coordinator roles, and a group of volunteer coordinator manager roles. There can be any number of staffing recruiter roles, any number of staffing account manager roles, any number of staffing manager roles, any number of human resources recruiter roles, any number of human resources manager roles, any number of placement officer roles, any number of placement manager roles, any number of placement director roles, any number of volunteer coordinator roles, and any number of volunteer coordinator manager roles. In some scenarios, a single user may play more than one role at any time.

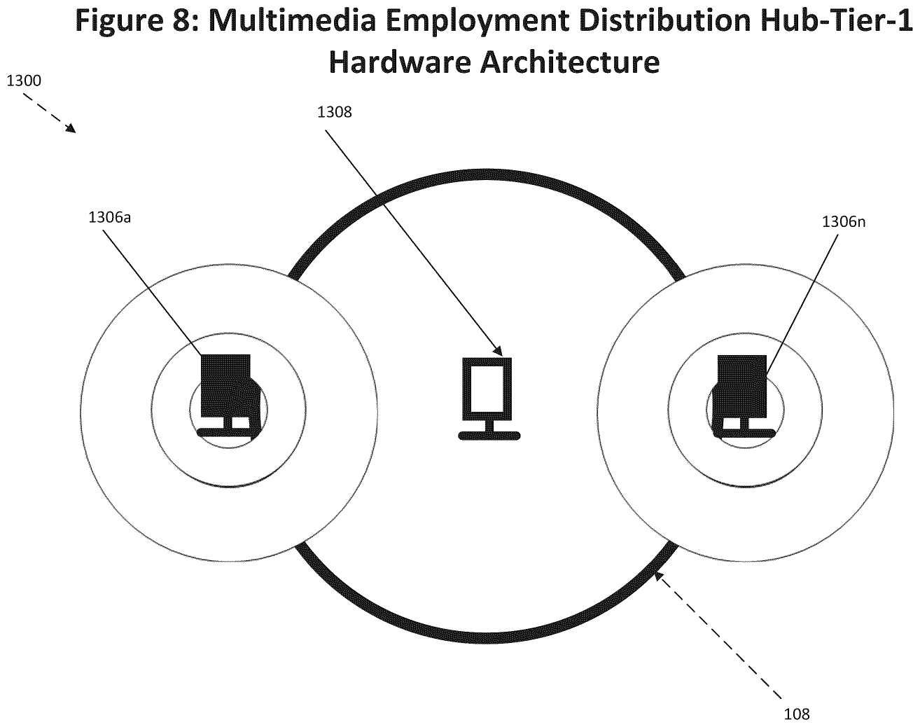

FIG. 8 illustrates an example multimedia employment distribution hub tier-1 hardware architecture 1300 illustrating a hardware based infrastructure solution, which includes special purpose hardware components of a tier-1 multimedia employment distribution hub. A special purpose hardware component system that can be employed in an operating environment and used to host or run a computer application implementing methods of this disclosure (such as method 4500, 4600, etc), as included on one or more computer readable storage mediums storing computer executable instructions for controlling the computer system, such as a computing device, to perform a process. A computing device typically includes one or more processors and memory. The processors may include two or more processing cores on a chip or two or more processor chips. The computing device can also have one or more additional processing or specialized processors, such as graphics processor for general purpose computing on graphics processor units, to perform processing functions offloaded from the processor. Memory may be arranged in a hierarchy and may include one or more levels of cache. Memory may be volatile (such as random access memory (RAM)), non-volatile (such as read only memory (ROM), flash memory, etc.) or some combination of the two. The computing device can take one or more of several forms. Such forms include a tablet, a personal computer, a workstation, a server, a handheld device, a consumer electronic device, or other, and can be a stand-alone device or configured as part of a computer network, computer cluster, cloud services infrastructure, or other. Computing device may also include additional storage. Storage may be removable and/or non-removable and can include magnetic or optical disks or solid-state memory, or flash storage devices. Computer storage media includes Volatile and non-volatile, removable and non-removable media implemented in any suitable method or technology for storage of information Such as computer readable instructions, data structures, program modules or other data. A propagating signal by itself does not qualify as storage media. Computing device often includes one or more input and/or output connections, such as USB connections, display ports, proprietary connections, and other to connect various devices such as keyboard, pointing device (e.g., mouse), pen, voice input device (e.g. microphone), video camera, touch input device, or other. Output devices may include devices such as a display, speakers, printer, or the like. Computing device often includes one or more communication connections that allow computing device to communicate with other computers/applications. Example communication connections can include, but are not limited to, an Ethernet interface, a wireless interface, a bus interface, a storage area network interface, a proprietary interface. The communication connections can be used to couple the computing device to a computer network, which is a computing devices and possibly other devices interconnected by communications channels that facilitate communications and allows sharing of resources and information among interconnected devices. Examples of computer networks include a local area network, a wide area network, the Internet, or other network. Special purpose media delivery computer systems are optimized for storage and delivery of respective media content, such as video, audio, graphics, virtual reality, augmented reality, and text. Computing device can be configured to run an operating system Software program and one or more computer Software applications, which make up a system platform. A computer Software application configured to execute on the computing device is typically provided as a set of instructions written in a programming language, implementing methods of this disclosure, such as 4500, 4600, etc. A computer application configured to execute on the computing device includes at least one computing process (or computing task), which is an executing program. Each computing process provides the computing resources to execute the program. Multimedia employment distribution hub tier-1 hardware architecture 1300 includes a group of tier-1 employment core appliances 1306a-1306n, a group of tier-1 employment hub appliances 1308 and tier-1 employment hub 108.

Group of tier-1 employment core appliances 1306a-1306n comprises: a group of tier-1 outbound relationship core appliances; a group of tier-1 outbound security core appliances; a group of tier-1 outbound video content core appliances; a group of tier-1 outbound audio content core appliances; a group of tier-1 outbound graphics content core appliances; a group of tier-1 outbound text content core appliances; a group of tier-1 outbound virtual reality content core appliances; a group of tier-1 outbound augmented reality content core appliances; a group of tier-1 inbound relationship core appliances; a group of tier-1 inbound security core appliances; a group of tier-1 inbound video content core appliances; a group of tier-1 inbound audio content core appliances; a group of tier-1 inbound graphics content core appliances; a group of tier-1 inbound text content core appliances; a group of tier-1 inbound virtual reality content core appliances; a group of tier-1 inbound augmented reality content core appliances. Example tier-1 employment core appliances can include a suitable combination of suitable computer servers, such as commodity grade servers, mid-range servers, high end servers, high availability servers, cloud based servers, and data center based servers, in-house servers, and other suitable servers. Employment core appliances can also be housed in a suitable combination of cloud service providers, data center providers, and in-house servers. Tier-1 employment core appliances can provide data backup, data archival, data restore capabilities, physical security, network security, and other suitable server services.

Group of tier-1 employment hub appliances 1308 comprises: a group of tier-1 outbound relationship hub appliances; a group of tier-1 outbound security hub appliances; a group of tier-1 outbound video content hub appliances; a group of tier-1 outbound audio content hub appliances; a group of tier-1 outbound graphics content hub appliances; a group of tier-1 outbound text content hub appliances; a group of tier-1 outbound virtual reality content hub appliances; a group of tier-1 outbound augmented reality content hub appliances; a group of tier-1 inbound relationship hub appliances; a group of tier-1 inbound security hub appliances; a group of tier-1 inbound video content hub appliances; a group of tier-1 inbound audio content hub appliances; a group of tier-1 inbound graphics content hub appliances; a group of tier-1 inbound text content hub appliances; a group of tier-1 inbound virtual reality content hub appliances; a group of tier-1 inbound augmented reality content hub appliances. Example tier-1 employment hub appliances can include a suitable combination of suitable computer servers, such as commodity grade servers, mid-range servers, high end servers, high availability servers, cloud based servers, and data center based servers, in-house servers, and other suitable servers. Employment hub appliances can also be housed in a suitable combination of cloud service providers, data center providers, and in-house servers.

Tier-1 Employment hub appliances can provide data backup, data archival, data restore capabilities, physical security, network security, and other suitable server services.

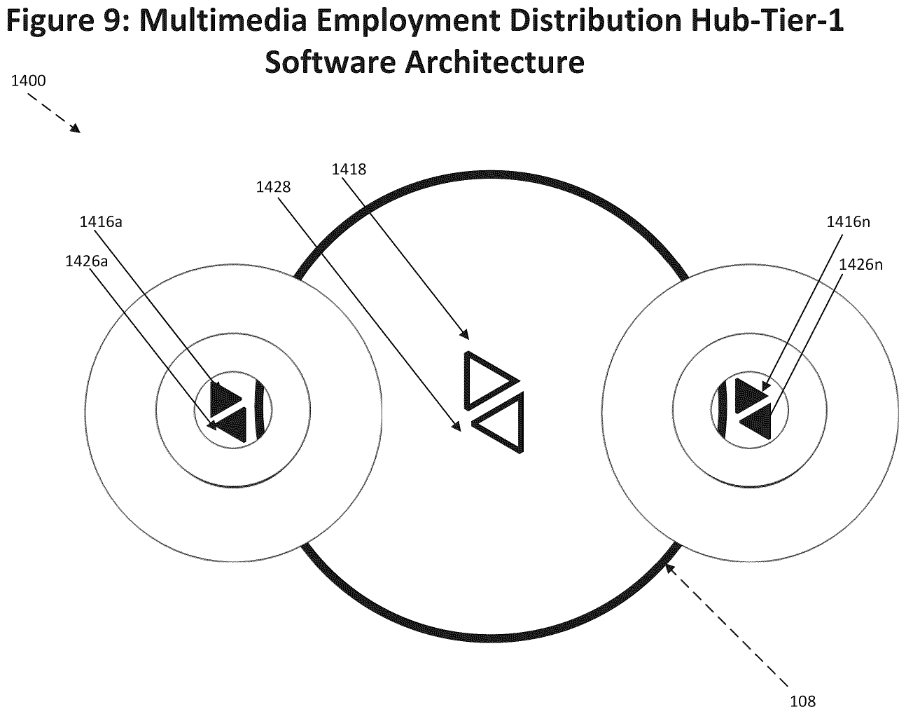

FIG. 9 is a diagram of an example multimedia employment distribution hub tier-1 software architecture illustrating a software application solution, which includes special purpose Software components of a tier-1 multimedia employment distribution hub.

FIG. 9 illustrates an example multimedia employment distribution hub tier-1 software architecture 1400 illustrating a software application Solution, which includes a special purpose software components of a multimedia employment distribution hub tier-1 system. Multimedia employment distribution hub tier-1 software architecture 1400 executes on multimedia employment distribution hub tier-1 hardware architecture 1300. Multimedia employment distribution hub tier-1 software architecture 1400 includes a group of outbound employment core applications 1416a-1416n, a group of inbound employment core applications 1426a-1426n, a group of outbound employment hub applications 1418, a group of inbound employment hub applications 1428 and tier-1 employment hub 108.

Group of tier-1 outbound employment core applications 1416a-1416n includes integration instructions for controlling communications and represents special purpose media delivery Software applications, which includes delivery instructions for optimal data transfer and protection of data, and comprises: a group of tier-1 outbound relationship core application Software components (which executes on a group of tier-1 outbound relationship core appliances 1306a-1306n respectively); a group of tier-1 outbound security core application Software components (which executes on a group of tier-1 outbound security core appliances 1306a-1306n respectively); a group of tier-1 outbound video content core application software components (which executes on a group of tier-1 outbound video content core appliances 1306a-1306n respectively); a group of tier-1 outbound audio content core application Software components (which executes on a group of tier-1 outbound audio content core appliances 1306a-1306n respectively); a group of tier-1 outbound graphics content core application Software components (which executes on a group of tier-1 outbound graphics content core appliances 1306a-1306n respectively); and a group of tier-1 outbound text content core application software components (which executes on a group of tier-1 outbound text content core appliances 1306a-1306n respectively); a group of tier-1 outbound virtual reality content core application software components (which executes on a group of tier-1 outbound virtual reality content core appliances 1306a-1306n respectively); and a group of tier-1 outbound augmented reality content core application software components (which executes on a group of tier-1 outbound augmented reality content core appliances 1306a-1306n respectively).

Group of tier-1 inbound employment core applications 1426a-1426n includes integration instructions for controlling communications and represents special purpose media delivery Software applications, which includes delivery instructions for optimal data transfer and protection of data, and comprises: a group of tier-1 inbound relationship core application Software components (which executes on a group of tier-1 inbound relationship core appliances 1306a-1306n respectively); a group of tier-1 inbound security core application Software components (which executes on a group of tier-1 inbound security core appliances 1306a-1306n respectively); a group of tier-1 inbound video content core application software components (which executes on a group of tier-1 inbound video content core appliances 1306a-1306n respectively); a group of tier-1 inbound audio content core application Software components (which executes on a group of tier-1 inbound audio content core appliances 1306a-1306n respectively); a group of tier-1 inbound graphics content core application Software components (which executes on a group of tier-1 inbound graphics content core appliances 1306a-1306n respectively); and a group of tier-1 inbound text content core application software components (which executes on a group of tier-1 inbound text content core appliances 1306a-1306n respectively); a group of tier-1 inbound virtual reality content core application software components (which executes on a group of tier-1 inbound virtual reality content core appliances 1306a-1306n respectively); and a group of tier-1 inbound augmented reality content core application software components (which executes on a group of tier-1 inbound augmented reality content core appliances 1306a-1306n respectively).

Group of tier-1 outbound employment hub applications 1418 includes integration instructions for controlling communications and represents special purpose media delivery Software applications, which includes delivery instructions for optimal data transfer and protection of data, and comprises: a group of tier-1 outbound relationship hub application Software components (which executes on a group of tier-1 outbound relationship hub appliances 1308 respectively); a group of tier-1 outbound security hub application Software components (which executes on a group of tier-1 outbound security hub appliances 1308 respectively); a group of tier-1 outbound video content hub application software components (which executes on a group of tier-1 outbound video content hub appliances 1308 respectively); a group of tier-1 outbound audio content hub application Software components (which executes on a group of tier-1 outbound audio content hub appliances 1308 respectively); a group of tier-1 outbound graphics content hub application Software components (which executes on a group of tier-1 outbound graphics content hub appliances 1308 respectively); and a group of tier-1 outbound text content hub application software components (which executes on a group of tier-1 outbound text content hub appliances 1308 respectively); a group of tier-1 outbound virtual reality content hub application software components (which executes on a group of tier-1 outbound virtual reality content hub appliances 1308 respectively); and a group of tier-1 outbound augmented reality content hub application software components (which executes on a group of tier-1 outbound augmented reality content hub appliances 1308 respectively).

Group of tier-1 inbound employment hub applications 1428 includes integration instructions for controlling communications and represents special purpose media delivery Software applications, which includes delivery instructions for optimal data transfer and protection of data, and comprises: a group of tier-1 inbound relationship hub application Software components (which executes on a group of tier-1 inbound relationship hub appliances 1308 respectively); a group of tier-1 inbound security hub application Software components (which executes on a group of tier-1 inbound security hub appliances 1308 respectively); a group of tier-1 inbound video content hub application software components (which executes on a group of tier-1 inbound video content hub appliances 1308 respectively); a group of tier-1 inbound audio content hub application Software components (which executes on a group of tier-1 inbound audio content hub appliances 1308 respectively); a group of tier-1 inbound graphics content hub application Software components (which executes on a group of tier-1 inbound graphics content hub appliances 1308 respectively); and a group of tier-1 inbound text content hub application software components (which executes on a group of tier-1 inbound text content hub appliances 1308 respectively); a group of tier-1 inbound virtual reality content hub application software components (which executes on a group of tier-1 inbound virtual reality content hub appliances 1308 respectively); and a group of tier-1 inbound augmented reality content hub application software components (which executes on a group of tier-1 inbound augmented reality content hub appliances 1308 respectively).

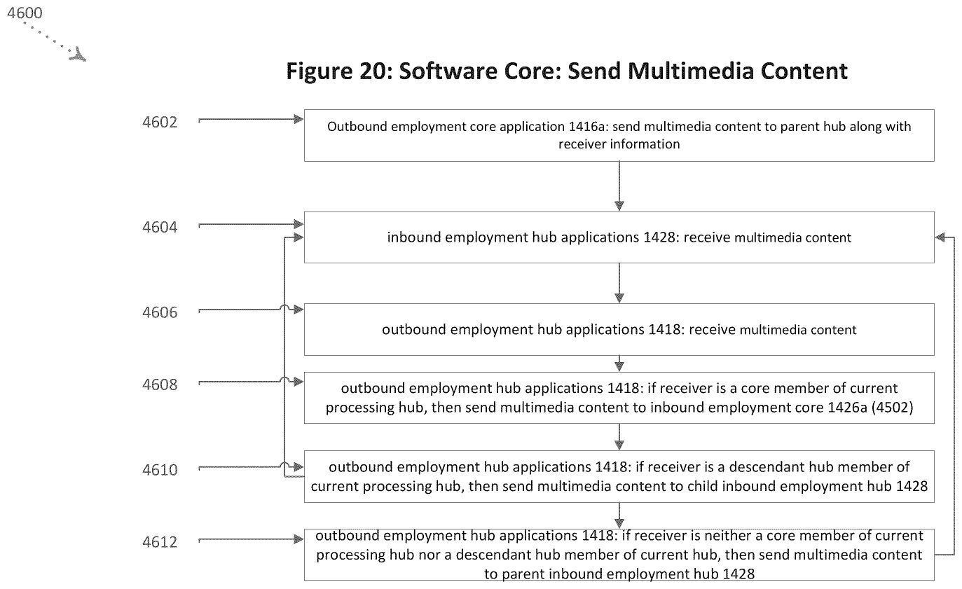

Multimedia employment distribution hub (108) receives multimedia content from an outbound employment core application 1416a of a sender core (106a) for distribution to an inbound employment core application 1426n of a receiver core (106n). If the receiver core (106n) is a core member of current distribution hub (108), then, current distribution hub (108) sends multimedia content to the respective inbound employment core application 1426n of a receiver core (106n), which is described in 4608 of 4600 of FIG. 20. If the receiver core (106n) is a descendant hub member of current distribution hub (108), then, current distribution hub (108) sends multimedia content to child inbound employment distribution hub 1428, which is described in 4610 of 4600 of FIG. 20. If the receiver core (106n) is neither a core member of current distribution hub (108) nor a descendant hub member of current distribution hub (108), then, current distribution hub (108) sends multimedia content to parent inbound employment distribution hub 1428, which is described in 4612 of 4600 of FIG. 20. For each distribution, the steps 4604 of 4600 through 4612 of 4600 are repeated until step 4608 of 4600 is reached. In essence, Multimedia employment distribution hub (108) acts as a multimedia employment content distributor between sender core (106a) and receiver core (106n). In this example, as the receiver core (106n) is a core member of current distribution hub (108), the current distribution hub (108) sends multimedia content to the respective inbound employment core application 1426n of the receiver core (106n) as per step 4608 of 4600 in the first iteration of the steps 4604 of 4600 through 4612 of 4600. Each multimedia employment distribution hub stores its parent employment distribution hub information, its employment core member information 106a through 106n, and complete chain of its descendent employment distribution hub member information, including employment core member information within the respective chain of descendent employment distribution hub member information to facilitate efficient multimedia employment content distribution. When a multimedia employment distribution hub is added as a child to an existing multimedia employment distribution hub, complete chain of its antecedent (hierarchical parents) are notified to store its newly added descendent employment distribution hub member information, including employment core member information within the respective chain of descendent employment distribution hub member information to facilitate effective multimedia employment content distribution. When a multimedia employment core is added as a child to an existing multimedia employment distribution hub, complete chain of its antecedent (hierarchical parents) are notified to store its newly added descendent employment core member information to facilitate effective multimedia employment content distribution. When a multimedia employment distribution hub is removed as a child from an existing multimedia employment distribution hub, complete chain of its antecedent (hierarchical parents) are notified to store the fact of removal of its currently removed descendent employment distribution hub member information, including complete chain of employment core member information within the respective chain of descendent employment distribution hub member information to facilitate effective multimedia employment content distribution. When a multimedia employment core is removed as a child from an existing multimedia employment distribution hub, complete chain of its antecedent (hierarchical parents) are notified to store the fact of removal of its currently removed descendent employment core member information to facilitate effective multimedia employment content distribution. When a failure of distribution of multimedia employment content is detected, a generative AI based self-healing process is initiated asynchronously, so that the complete chain of multimedia employment distribution hub structure stores accurate descendent employment distribution hub member information and accurate employment core member information within the respective chain of descendent employment distribution hub member information to facilitate effective multimedia employment content distribution. When a self-healing process fails within a pre-specified repeat count, and/or time limit, and/or cost limit, then, the failure of multimedia employment content distribution is notified back to the sender of the respective multimedia employment content, because it is likely that intended receiver employment core member (or the hierarchical parent employment distribution hub of the intended receiver employment core member) has been removed from the complete chain of multimedia employment distribution hub structure. In effect, the sender records the fact that the multimedia employment content was not received by the receiver.

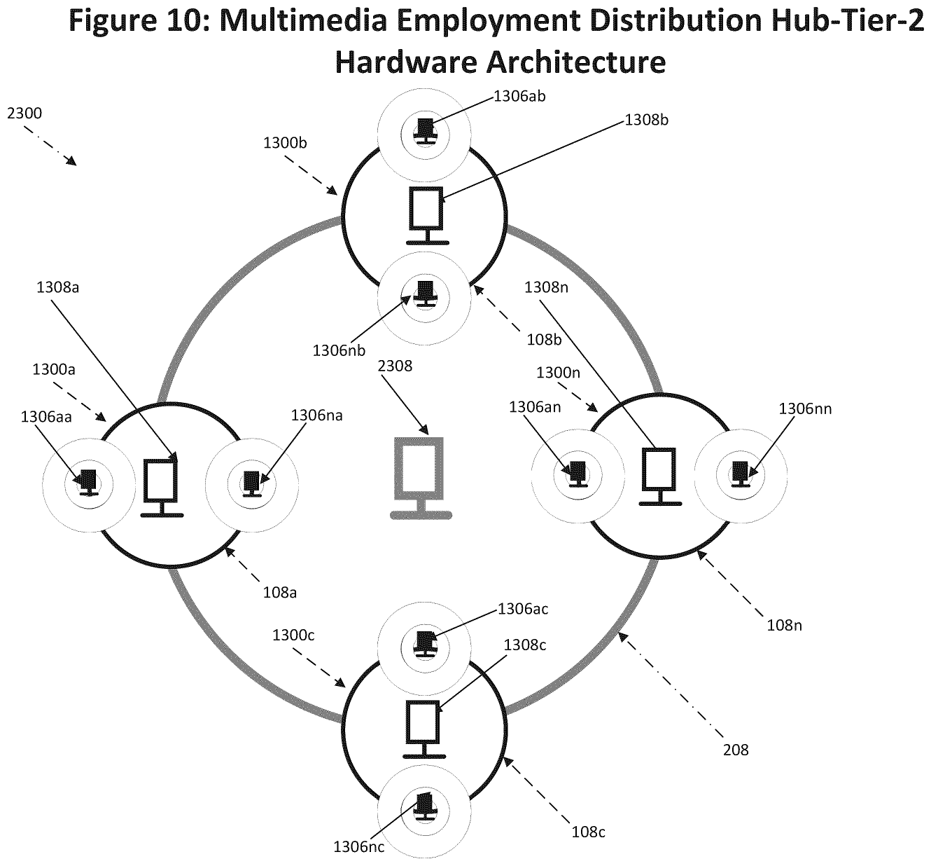

FIG. 10 illustrates an example multimedia employment distribution hub tier-2 hardware architecture 2300 illustrating a hardware based infrastructure solution, which includes special purpose hardware components of a tier-2 multimedia employment distribution hub. A special purpose hardware component system that can be employed in an operating environment and used to host or run a computer application implementing methods of this disclosure (such as method 4500, 4600, etc.), as included on one or more computer readable storage mediums storing computer executable instructions for controlling the computer system, such as a computing device, to perform a process. A computing device typically includes one or more processors and memory. The processors may include two or more processing cores on a chip or two or more processor chips. The computing device can also have one or more additional processing or specialized processors, such as graphics processor for general purpose computing on graphics processor units, to perform processing functions offloaded from the processor. Memory may be arranged in a hierarchy and may include one or more levels of cache. Memory may be volatile (such as random access memory (RAM)), non-volatile (such as read only memory (ROM), flash memory, etc.) or some combination of the two. The computing device can take one or more of several forms. Such forms include a tablet, a personal computer, a workstation, a server, a handheld device, a consumer electronic device, or other, and can be a stand-alone device or configured as part of a computer network, computer cluster, cloud services infrastructure, or other. Computing device may also include additional storage. Storage may be removable and/or non-removable and can include magnetic or optical disks or solid-state memory, or flash storage devices. Computer storage media includes Volatile and non-volatile, removable and non-removable media implemented in any suitable method or technology for storage of information Such as computer readable instructions, data structures, program modules or other data. A propagating signal by itself does not qualify as storage media. Computing device often includes one or more input and/or output connections, such as USB connections, display ports, proprietary connections, and other to connect various devices such as keyboard, pointing device (e.g., mouse), pen, voice input device (e.g. microphone), video camera, touch input device, or other. Output devices may include devices such as a display, speakers, printer, or the like. Computing device often includes one or more communication connections that allow computing device to communicate with other computers/applications. Example communication connections can include, but are not limited to, an Ethernet interface, a wireless interface, a bus interface, a storage area network interface, a proprietary interface. The communication connections can be used to couple the computing device to a computer network, which is a computing devices and possibly other devices interconnected by communications channels that facilitate communications and allows sharing of resources and information among interconnected devices. Examples of computer networks include a local area network, a wide area network, the Internet, or other network. Special purpose media delivery computer systems are optimized for storage and delivery of respective media content, such as video, audio, graphics, virtual reality, augmented reality, and text. Computing device can be configured to run an operating system Software program and one or more computer Software applications, which make up a system platform. A computer Software application configured to execute on the computing device is typically provided as a set of instructions written in a programming language, implementing methods of this disclosure, such 4500, 4600, etc. A computer application configured to execute on the computing device includes at least one computing process (or computing task), which is an executing program. Each computing process provides the computing resources to execute the program. Multimedia employment distribution hub tier-2 hardware architecture 2300 includes a group of Multimedia employment distribution hub tier-1 hardware architecture 1300a-1300n, a group of tier-1 employment core appliances 1306aa-1306nn, a group of tier-1 employment hub appliances 1308a-1308n, a group of tier-2 employment hub appliances 2308, a group of tier-1 employment hubs 108a-108n, and tier-2 employment hub 208.

Group of tier-1 employment core appliances 1306aa-1306nn comprises: a group of tier-1 outbound relationship core appliances; a group of tier-1 outbound security core appliances; a group of tier-1 outbound video content core appliances; a group of tier-1 outbound audio content core appliances; a group of tier-1 outbound graphics content core appliances; a group of tier-1 outbound text content core appliances; a group of tier-1 outbound virtual reality content core appliances; a group of tier-1 outbound augmented reality content core appliances; a group of tier-1 inbound relationship core appliances; a group of tier-1 inbound security core appliances; a group of tier-1 inbound video content core appliances; a group of tier-1 inbound audio content core appliances; a group of tier-1 inbound graphics content core appliances; a group of tier-1 inbound text content core appliances; a group of tier-1 inbound virtual reality content core appliances; a group of tier-1 inbound augmented reality content core appliances. Example tier-1 employment core appliances can include a suitable combination of suitable computer servers, such as commodity grade servers, mid-range servers, high end servers, high availability servers, cloud based servers, and data center based servers, in-house servers, and other suitable servers. Employment core appliances can also be housed in a suitable combination of cloud service providers, data center providers, and in-house servers. Tier-1 employment core appliances can provide data backup, data archival, data restore capabilities, physical security, network security, and other suitable server services.

Group of tier-1 employment hub appliances 1308a-1308n comprises: a group of tier-1 outbound relationship hub appliances; a group of tier-1 outbound security hub appliances; a group of tier-1 outbound video content hub appliances; a group of tier-1 outbound audio content hub appliances; a group of tier-1 outbound graphics content hub appliances; a group of tier-1 outbound text content hub appliances; a group of tier-1 outbound virtual reality content hub appliances; a group of tier-1 outbound augmented reality content hub appliances; a group of tier-1 inbound relationship hub appliances; a group of tier-1 inbound security hub appliances; a group of tier-1 inbound video content hub appliances; a group of tier-1 inbound audio content hub appliances; a group of tier-1 inbound graphics content hub appliances; a group of tier-1 inbound text content hub appliances; a group of tier-1 inbound virtual reality content hub appliances; a group of tier-1 inbound augmented reality content hub appliances. Example tier-1 employment hub appliances can include a suitable combination of suitable computer servers, such as commodity grade servers, mid-range servers, high end servers, high availability servers, cloud based servers, and data center based servers, in-house servers, and other suitable servers. Tier-1 Employment hub appliances can also be housed in a suitable combination of cloud service providers, data center providers, and in-house servers. Employment hub appliances can provide data backup, data archival, data restore capabilities, physical security, network security, and other suitable server services.

Group of tier-2 employment hub appliances 2308 comprises: a group of tier-2 outbound relationship hub appliances; a group of tier-2 outbound security hub appliances; a group of tier-2 outbound video content hub appliances; a group of tier-2 outbound audio content hub appliances; a group of tier-2 outbound graphics content hub appliances; a group of tier-2 outbound text content hub appliances; a group of tier-2 outbound virtual reality content hub appliances; a group of tier-2 outbound augmented reality content hub appliances; a group of tier-2 inbound relationship hub appliances; a group of tier-2 inbound security hub appliances; a group of tier-2 inbound video content hub appliances; a group of tier-2 inbound audio content hub appliances; a group of tier-2 inbound graphics content hub appliances; a group of tier-2 inbound text content hub appliances; a group of tier-2 inbound virtual reality content hub appliances; a group of tier-2 inbound augmented reality content hub appliances. Example tier-2 employment hub appliances can include a suitable combination of suitable computer servers, such as commodity grade servers, mid-range servers, high end servers, high availability servers, cloud based servers, and data center based servers, in-house servers, and other suitable servers. Tier-2 Employment hub appliances can also be housed in a suitable combination of cloud service providers, data center providers, and in-house servers. Employment hub appliances can provide data backup, data archival, data restore capabilities, physical security, network security, and other suitable server services.

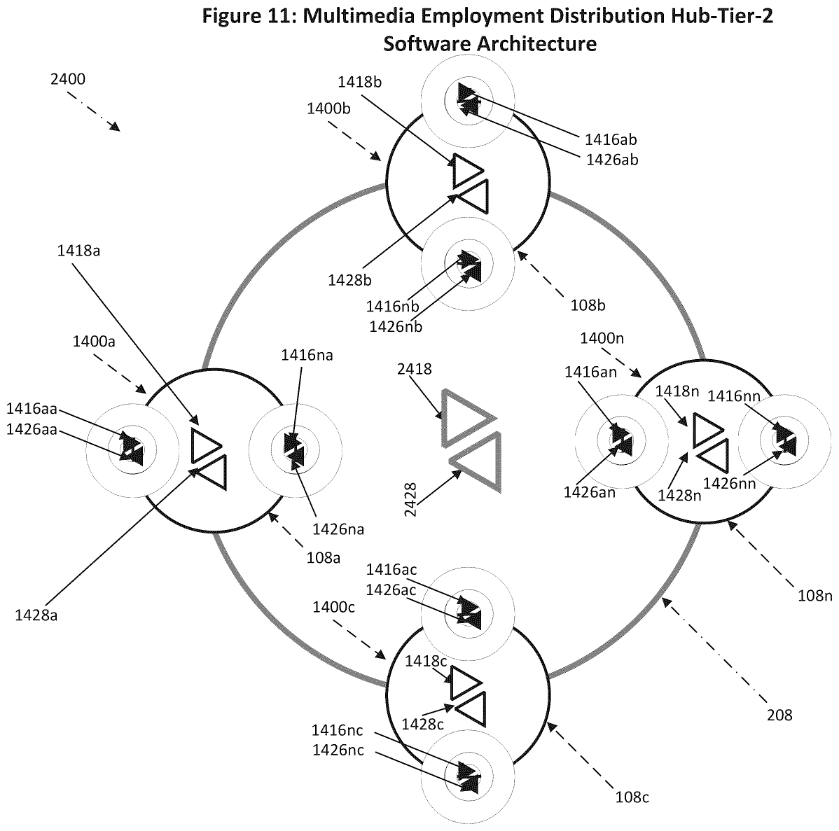

FIG. 11 is a diagram of an example multimedia employment distribution hub tier-2 software architecture illustrating a software application solution, which includes special purpose Software components of a tier-2 multimedia employment distribution hub.

FIG. 11 illustrates an example multimedia employment distribution hub tier-2 software architecture 2400 illustrating a software application Solution, which includes a special purpose software components of a multimedia employment distribution hub tier-2 system. Multimedia employment distribution hub tier-2 software architecture 2400 executes on multimedia employment distribution hub tier-2 hardware architecture 2300. Multimedia employment distribution hub tier-2 software architecture 2400 includes a group of Multimedia employment distribution hub tier-1 software architecture 1400a-1400n, a group of tier-1 outbound employment core applications 1416aa-1416nn, a group of tier-1 inbound employment core applications 1426aa-1426nn, a group of tier-1 outbound employment hub applications 1418a-1418n, a group of tier-1 inbound employment hub applications 1428a-1428n, a group of tier-2 outbound employment hub applications 2418, a group of tier-2 inbound employment hub applications 2428, a group of tier-1 employment hub 108a-108n, and tier-2 employment hub 208.

Group of tier-1 outbound employment core applications 1416aa-1416nn includes integration instructions for controlling communications and represents special purpose media delivery Software applications, which includes delivery instructions for optimal data transfer and protection of data, and comprises: a group of tier-1 outbound relationship core application Software components (which executes on a group of tier-1 outbound relationship core appliances 1306aa-1306nn); a group of tier-1 outbound security core application Software components (which executes on a group of tier-1 outbound security core appliances 1306aa-1306nn); a group of tier-1 outbound video content core application software components (which executes on a group of tier-1 outbound video content core appliances 1306aa-1306nn); a group of tier-1 outbound audio content core application Software components (which executes on a group of tier-1 outbound audio content core appliances 1306aa-1306nn); a group of tier-1 outbound graphics content core application Software components (which executes on a group of tier-1 outbound graphics content core appliances 1306aa-1306nn); and a group of tier-1 outbound text content core application software components (which executes on a group of tier-1 outbound text content core appliances 1306aa-1306nn).

Group of tier-1 outbound employment hub applications 1418a through 1418n includes integration instructions for controlling communications and represents special purpose media delivery Software applications, which includes delivery instructions for optimal data transfer and protection of data, and comprises: a group of tier-1 outbound relationship hub application Software components (which executes on a group of tier-1 outbound relationship hub appliances 1308a through 1308n respectively); a group of tier-1 outbound security hub application Software components (which executes on a group of tier-1 outbound security hub appliances 1308a through 1308n respectively); a group of tier-1 outbound video content hub application software components (which executes on a group of tier-1 outbound video content hub appliances 1308a through 1308n respectively); a group of tier-1 outbound audio content hub application Software components (which executes on a group of tier-1 outbound audio content hub appliances 1308a through 1308n respectively); a group of tier-1 outbound graphics content hub application Software components (which executes on a group of tier-1 outbound graphics content hub appliances 1308a through 1308n respectively); and a group of tier-1 outbound text content hub application software components (which executes on a group of tier-1 outbound text content hub appliances 1308a through 1308n respectively); a group of tier-1 outbound virtual reality content hub application software components (which executes on a group of tier-1 outbound virtual reality content hub appliances 1308a through 1308n respectively); and a group of tier-1 outbound augmented reality content hub application software components (which executes on a group of tier-1 outbound augmented reality content hub appliances 1308a through 1308n respectively).

Group of tier-1 inbound employment core applications 1426aa-1426nn includes integration instructions for controlling communications and represents special purpose media delivery Software applications, which includes delivery instructions for optimal data transfer and protection of data, and comprises: a group of tier-1 inbound relationship core application Software components (which executes on a group of tier-1 inbound relationship core appliances 1306aa-1306nn); a group of tier-1 inbound security core application Software components (which executes on a group of tier-1 inbound security core appliances 1306aa-1306nn); a group of tier-1 inbound video content core application software components (which executes on a group of tier-1 inbound video content core appliances 1306aa-1306nn); a group of tier-1 inbound audio content core application Software components (which executes on a group of tier-1 inbound audio content core appliances 1306aa-1306nn); a group of tier-1 inbound graphics content core application Software components (which executes on a group of tier-1 inbound graphics content core appliances 1306aa-1306nn); and a group of tier-1 inbound text content core application software components (which executes on a group of tier-1 inbound text content core appliances 1306aa-1306nn).

Group of tier-1 inbound employment hub applications 1428 includes integration instructions for controlling communications and represents special purpose media delivery Software applications, which includes delivery instructions for optimal data transfer and protection of data, and comprises: a group of tier-1 inbound relationship hub application Software components (which executes on a group of tier-1 inbound relationship hub appliances 1308a through 1308n respectively); a group of tier-1 inbound security hub application Software components (which executes on a group of tier-1 inbound security hub appliances 1308a through 1308n respectively); a group of tier-1 inbound video content hub application software components (which executes on a group of tier-1 inbound video content hub appliances 1308a through 1308n respectively); a group of tier-1 inbound audio content hub application Software components (which executes on a group of tier-1 inbound audio content hub appliances 1308a through 1308n respectively); a group of tier-1 inbound graphics content hub application Software components (which executes on a group of tier-1 inbound graphics content hub appliances 1308a through 1308n respectively); a group of tier-1 inbound text content hub application software components (which executes on a group of tier-1 inbound text content hub appliances 1308a through 1308n respectively); a group of tier-1 inbound virtual reality content hub application software components (which executes on a group of tier-1 inbound virtual reality content hub appliances 1308a through 1308n respectively); and a group of tier-1 inbound augmented reality content hub application software components (which executes on a group of tier-1 inbound augmented reality content hub appliances 1308a through 1308n respectively).

Group of tier-2 outbound employment hub applications 2418 includes integration instructions for controlling communications and represents special purpose media delivery Software applications, which includes delivery instructions for optimal data transfer and protection of data, and comprises: a group of tier-2 outbound relationship hub application Software components (which executes on a group of tier-2 outbound relationship hub appliances 2308); a group of tier-2 outbound security hub application Software components (which executes on a group of tier-2 outbound security hub appliances 2308); a group of tier-2 outbound video content hub application software components (which executes on a group of tier-2 outbound video content hub appliances 2308); a group of tier-2 outbound audio content hub application Software components (which executes on a group of tier-2 outbound audio content hub appliances 2308); a group of tier-2 outbound graphics content hub application Software components (which executes on a group of tier-2 outbound graphics content hub appliances 2308); and a group of tier-2 outbound text content hub application software components (which executes on a group of tier-2 outbound text content hub appliances 2308).

Group of tier-2 inbound employment hub applications 2428 includes integration instructions for controlling communications and represents special purpose media delivery Software applications, which includes delivery instructions for optimal data transfer and protection of data, and comprises: a group of tier-2 inbound relationship hub application Software components (which executes on a group of tier-2 inbound relationship hub appliances 2308); a group of tier-2 inbound security hub application Software components (which executes on a group of tier-2 inbound security hub appliances 2308); a group of tier-2 inbound video content hub application software components (which executes on a group of tier-2 inbound video content hub appliances 2308); a group of tier-2 inbound audio content hub application Software components (which executes on a group of tier-2 inbound audio content hub appliances 2308); a group of tier-2 inbound graphics content hub application Software components (which executes on a group of tier-2 inbound graphics content hub appliances 2308); and a group of tier-2 inbound text content hub application software components (which executes on a group of tier-2 inbound text content hub appliances 2308).

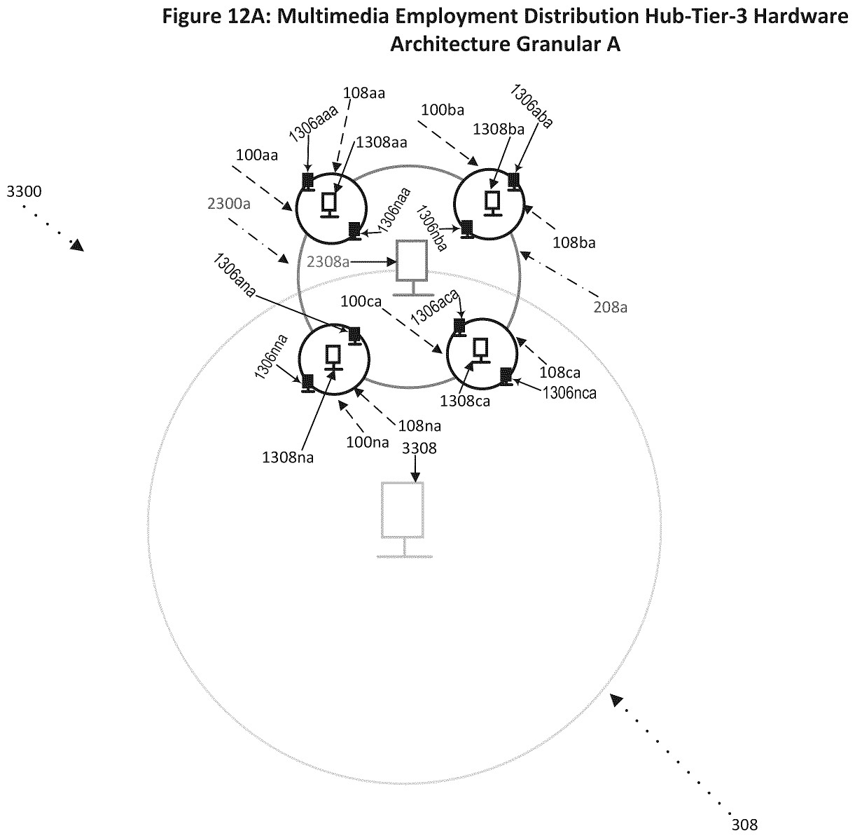

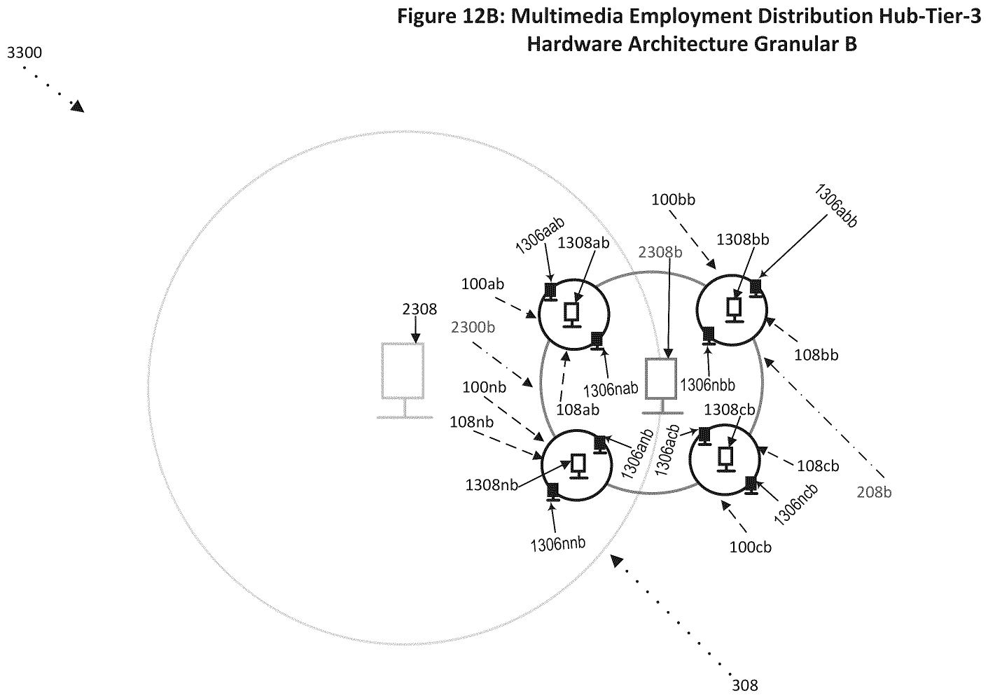

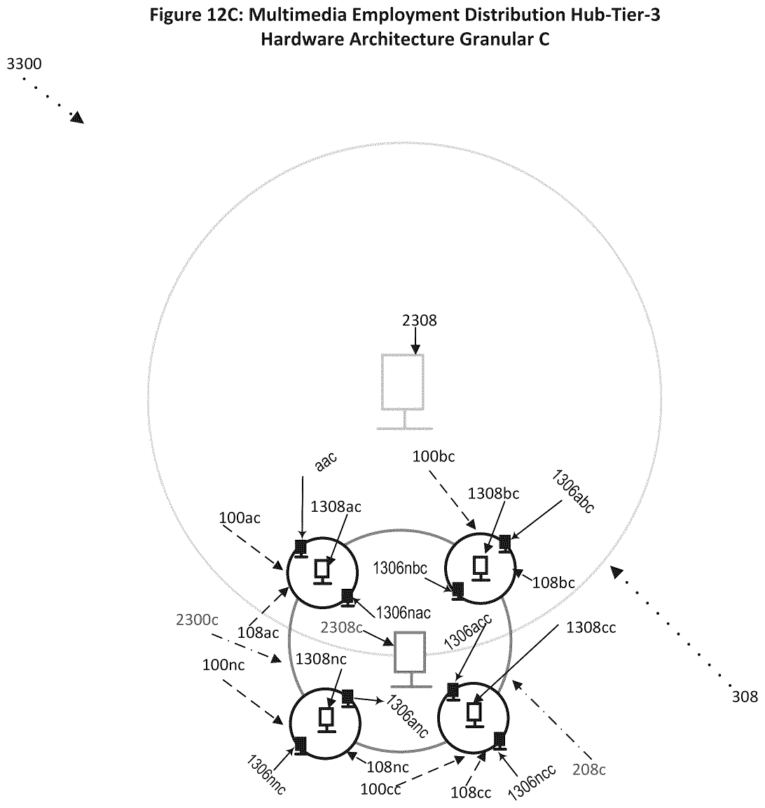

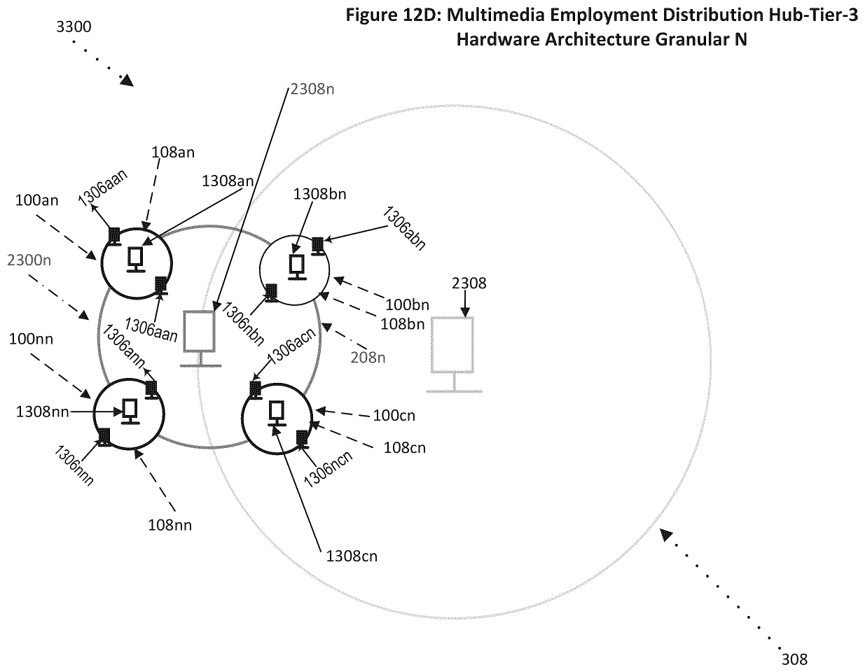

FIG. 12A illustrates an example multimedia employment distribution hub tier-3 hardware architecture 3300 illustrating a hardware based infrastructure solution, which includes special purpose hardware components of a tier-3 multimedia employment distribution hub. A special purpose hardware component system that can be employed in an operating environment and used to host or run a computer application implementing methods of this disclosure (such as method 4500, 4600, etc.), as included on one or more computer readable storage mediums storing computer executable instructions for controlling the computer system, such as a computing device, to perform a process. A computing device typically includes one or more processors and memory. The processors may include two or more processing cores on a chip or two or more processor chips. The computing device can also have one or more additional processing or specialized processors, such as graphics processor for general purpose computing on graphics processor units, to perform processing functions offloaded from the processor. Memory may be arranged in a hierarchy and may include one or more levels of cache. Memory may be volatile (such as random access memory (RAM)), non-volatile (such as read only memory (ROM), flash memory, etc.) or some combination of the two. The computing device can take one or more of several forms. Such forms include a tablet, a personal computer, a workstation, a server, a handheld device, a consumer electronic device, or other, and can be a stand-alone device or configured as part of a computer network, computer cluster, cloud services infrastructure, or other. Computing device may also include additional storage. Storage may be removable and/or non-removable and can include magnetic or optical disks or solid-state memory, or flash storage devices. Computer storage media includes Volatile and non-volatile, removable and non-removable media implemented in any suitable method or technology for storage of information Such as computer readable instructions, data structures, program modules or other data. A propagating signal by itself does not qualify as storage media. Computing device often includes one or more input and/or output connections, such as USB connections, display ports, proprietary connections, and other to connect various devices such as keyboard, pointing device (e.g., mouse), pen, voice input device (e.g. microphone), video camera, touch input device, or other. Output devices may include devices such as a display, speakers, printer, or the like. Computing device often includes one or more communication connections that allow computing device to communicate with other computers/applications. Example communication connections can include, but are not limited to, an Ethernet interface, a wireless interface, a bus interface, a storage area network interface, a proprietary interface. The communication connections can be used to couple the computing device to a computer network, which is a computing devices and possibly other devices interconnected by communications channels that facilitate communications and allows sharing of resources and information among interconnected devices. Examples of computer networks include a local area network, a wide area network, the Internet, or other network. Special purpose media delivery computer systems are optimized for storage and delivery of respective media content, such as video, audio, graphics, virtual reality, augmented reality, and text. Computing device can be configured to run an operating system Software program and one or more computer Software applications, which make up a system platform. A computer Software application configured to execute on the computing device is typically provided as a set of instructions written in a programming language, implementing methods of this disclosure, such as 4500, 4600, etc. A computer application configured to execute on the computing device includes at least one computing process (or computing task), which is an executing program. Each computing process provides the computing resources to execute the program. Multimedia employment distribution hub tier-3 hardware architecture 3300 includes a group of Multimedia employment distribution hub tier-2 hardware architecture 2300a, a group of Multimedia employment distribution hub tier-1 hardware architecture 100aa-100na, a group of tier-1 employment core appliances 1306aaa-1306nna, a group of tier-1 employment hub appliances 1308aa-1308na, a group of tier-2 employment hub appliances 2308a, a group of tier-3 employment hub appliances 3308, a group of tier-1 employment hubs 108aa-108na, and tier-2 employment hub 208a, and tier-3 employment hub 308.

Group of tier-1 employment core appliances 1306aaa-1306nna comprises: a group of tier-1 outbound relationship core appliances; a group of tier-1 outbound security core appliances; a group of tier-1 outbound video content core appliances; a group of tier-1 outbound audio content core appliances; a group of tier-1 outbound graphics content core appliances; a group of tier-1 outbound text content core appliances; a group of tier-1 inbound relationship core appliances; a group of tier-1 inbound security core appliances; a group of tier-1 inbound video content core appliances; a group of tier-1 inbound audio content core appliances; a group of tier-1 inbound graphics content core appliances; a group of tier-1 inbound text content core appliances. Example tier-1 employment core appliances can include a suitable combination of suitable computer servers, such as commodity grade servers, mid-range servers, high end servers, high availability servers, cloud based servers, and data center based servers, in-house servers, and other suitable servers. Employment core appliances can also be housed in a suitable combination of cloud service providers, data center providers, and in-house servers. Tier-1 employment core appliances can provide data backup, data archival, data restore capabilities, physical security, network security, and other suitable server services.

Group of tier-1 employment hub appliances 1308aa-1308na comprises: a group of tier-1 outbound relationship hub appliances; a group of tier-1 outbound security hub appliances; a group of tier-1 outbound video content hub appliances; a group of tier-1 outbound audio content hub appliances; a group of tier-1 outbound graphics content hub appliances; a group of tier-1 outbound text content hub appliances; a group of tier-1 inbound relationship hub appliances; a group of tier-1 inbound security hub appliances; a group of tier-1 inbound video content hub appliances; a group of tier-1 inbound audio content hub appliances; a group of tier-1 inbound graphics content hub appliances; a group of tier-1 inbound text content hub appliances. Example tier-1 employment hub appliances can include a suitable combination of suitable computer servers, such as commodity grade servers, mid-range servers, high end servers, high availability servers, cloud based servers, and data center based servers, in-house servers, and other suitable servers. Tier-1 Employment hub appliances can also be housed in a suitable combination of cloud service providers, data center providers, and in-house servers. Employment hub appliances can provide data backup, data archival, data restore capabilities, physical security, network security, and other suitable server services.

Group of tier-2 employment hub appliances 2308a comprises: a group of tier-2 outbound relationship hub appliances; a group of tier-2 outbound security hub appliances; a group of tier-2 outbound video content hub appliances; a group of tier-2 outbound audio content hub appliances; a group of tier-2 outbound graphics content hub appliances; a group of tier-2 outbound text content hub appliances; a group of tier-2 inbound relationship hub appliances; a group of tier-2 inbound security hub appliances; a group of tier-2 inbound video content hub appliances; a group of tier-2 inbound audio content hub appliances; a group of tier-2 inbound graphics content hub appliances; a group of tier-2 inbound text content hub appliances. Example tier-2 employment hub appliances can include a suitable combination of suitable computer servers, such as commodity grade servers, mid-range servers, high end servers, high availability servers, cloud based servers, and data center based servers, in-house servers, and other suitable servers. Tier-2 Employment hub appliances can also be housed in a suitable combination of cloud service providers, data center providers, and in-house servers. Employment hub appliances can provide data backup, data archival, data restore capabilities, physical security, network security, and other suitable server services.

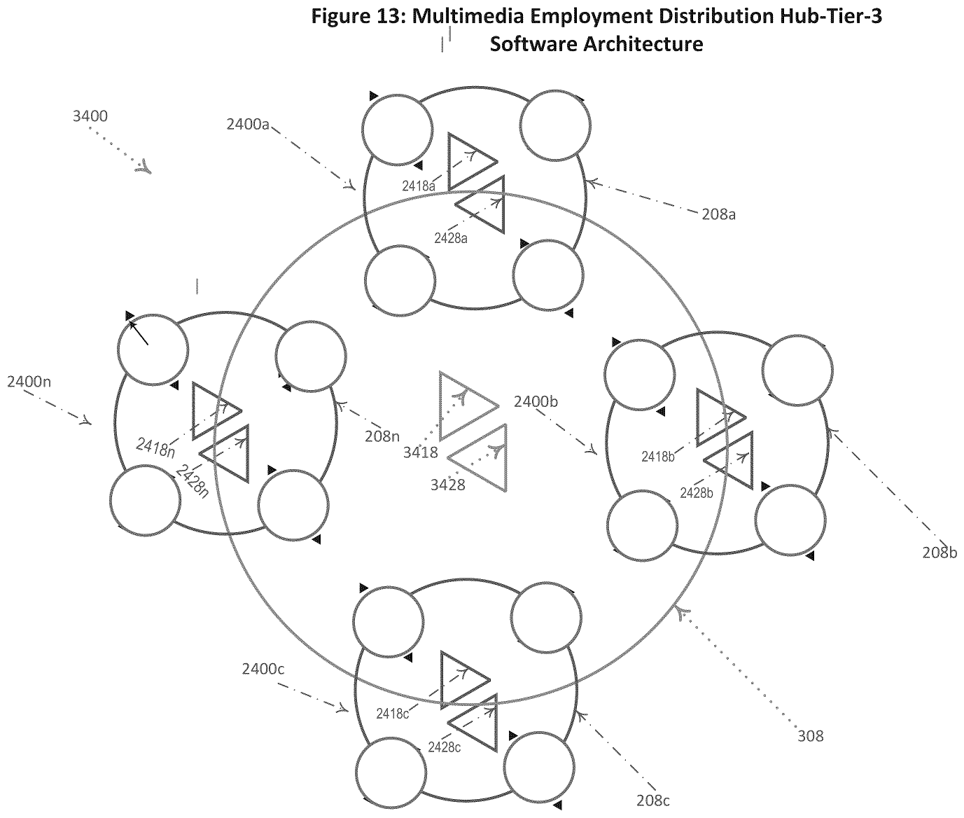

FIG. 13 illustrates an example multimedia employment distribution hub tier-3 software architecture 3400 illustrating a software application Solution, which includes a special purpose software components of a multimedia employment distribution hub tier-3 system. Multimedia employment distribution hub tier-3 software architecture 3400 executes on multimedia employment distribution hub tier-3 hardware architecture 3300. Multimedia employment distribution hub tier-3 software architecture 3400 includes a group of Multimedia employment distribution hub tier-2 software architecture 2400a-n, a group of tier-2 outbound employment hub applications 2418a-n, a group of tier-2 inbound employment hub applications 2428a-n, tier-2 employment hub 208a-n, and tier-3 employment hub 308.

Group of tier-2 outbound employment hub applications 2418a-n includes integration instructions for controlling communications and represents special purpose media delivery Software applications, which includes delivery instructions for optimal data transfer and protection of data, and comprises: a group of tier-2 outbound relationship hub application Software components (which executes on a group of tier-2 outbound relationship hub appliances 2308a-n respectively); a group of tier-2 outbound security hub application Software components (which executes on a group of tier-2 outbound security hub appliances 2308a-n respectively); a group of tier-2 outbound video content hub application software components (which executes on a group of tier-2 outbound video content hub appliances 2308a-n respectively); a group of tier-2 outbound audio content hub application Software components (which executes on a group of tier-2 outbound audio content hub appliances 2308a-n respectively); a group of tier-2 outbound graphics content hub application Software components (which executes on a group of tier-2 outbound graphics content hub appliances 2308a-n respectively); and a group of tier-2 outbound text content hub application software components (which executes on a group of tier-2 outbound text content hub appliances 2308a-n respectively).

Group of tier-2 inbound employment hub applications 2428a-n includes integration instructions for controlling communications and represents special purpose media delivery Software applications, which includes delivery instructions for optimal data transfer and protection of data, and comprises: a group of tier-2 inbound relationship hub application Software components (which executes on a group of tier-2 inbound relationship hub appliances 2308a-n respectively); a group of tier-2 inbound security hub application Software components (which executes on a group of tier-2 inbound security hub appliances 2308a-n respectively); a group of tier-2 inbound video content hub application software components (which executes on a group of tier-2 inbound video content hub appliances 2308a-n respectively); a group of tier-2 inbound audio content hub application Software components (which executes on a group of tier-2 inbound audio content hub appliances 2308a-n respectively); a group of tier-2 inbound graphics content hub application Software components (which executes on a group of tier-2 inbound graphics content hub appliances 2308a-n respectively); and a group of tier-2 inbound text content hub application software components (which executes on a group of tier-2 inbound text content hub appliances 2308a-n respectively).

Group of tier-2 outbound employment hub applications 3418 includes integration instructions for controlling communications and represents special purpose media delivery Software applications, which includes delivery instructions for optimal data transfer and protection of data, and comprises: a group of tier-2 outbound relationship hub application Software components (which executes on a group of tier-2 outbound relationship hub appliances 3308); a group of tier-2 outbound security hub application Software components (which executes on a group of tier-2 outbound security hub appliances 3308); a group of tier-2 outbound video content hub application software components (which executes on a group of tier-2 outbound video content hub appliances 3308); a group of tier-2 outbound audio content hub application Software components (which executes on a group of tier-2 outbound audio content hub appliances 3308); a group of tier-2 outbound graphics content hub application Software components (which executes on a group of tier-2 outbound graphics content hub appliances 3308); and a group of tier-2 outbound text content hub application software components (which executes on a group of tier-2 outbound text content hub appliances 3308).

Group of tier-2 inbound employment hub applications 3428 includes integration instructions for controlling communications and represents special purpose media delivery Software applications, which includes delivery instructions for optimal data transfer and protection of data, and comprises: a group of tier-2 inbound relationship hub application Software components (which executes on a group of tier-2 inbound relationship hub appliances 3308); a group of tier-2 inbound security hub application Software components (which executes on a group of tier-2 inbound security hub appliances 3308); a group of tier-2 inbound video content hub application software components (which executes on a group of tier-2 inbound video content hub appliances 3308); a group of tier-2 inbound audio content hub application Software components (which executes on a group of tier-2 inbound audio content hub appliances 3308); a group of tier-2 inbound graphics content hub application Software components (which executes on a group of tier-2 inbound graphics content hub appliances 3308); and a group of tier-2 inbound text content hub application software components (which executes on a group of tier-2 inbound text content hub appliances 3308).

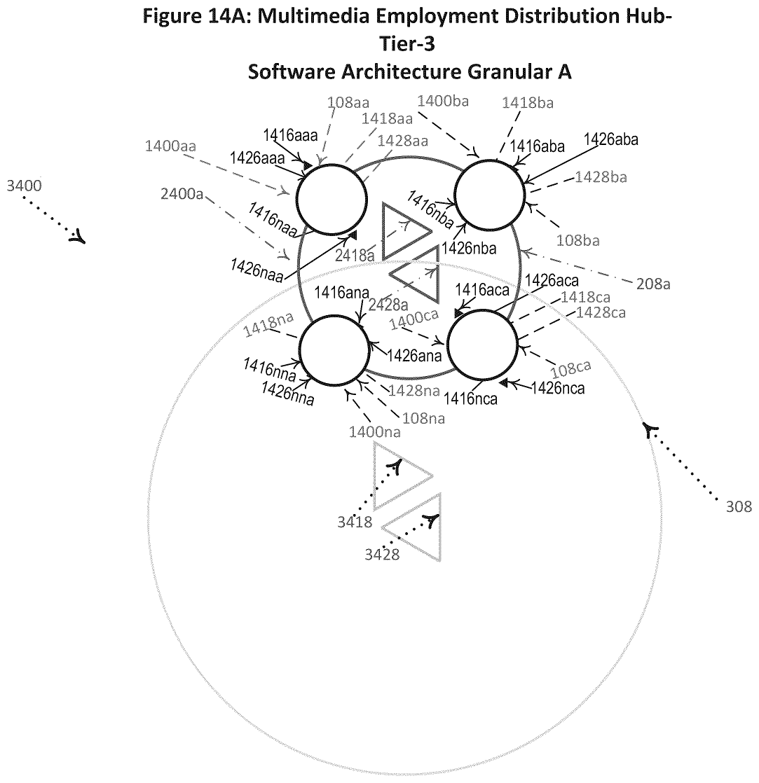

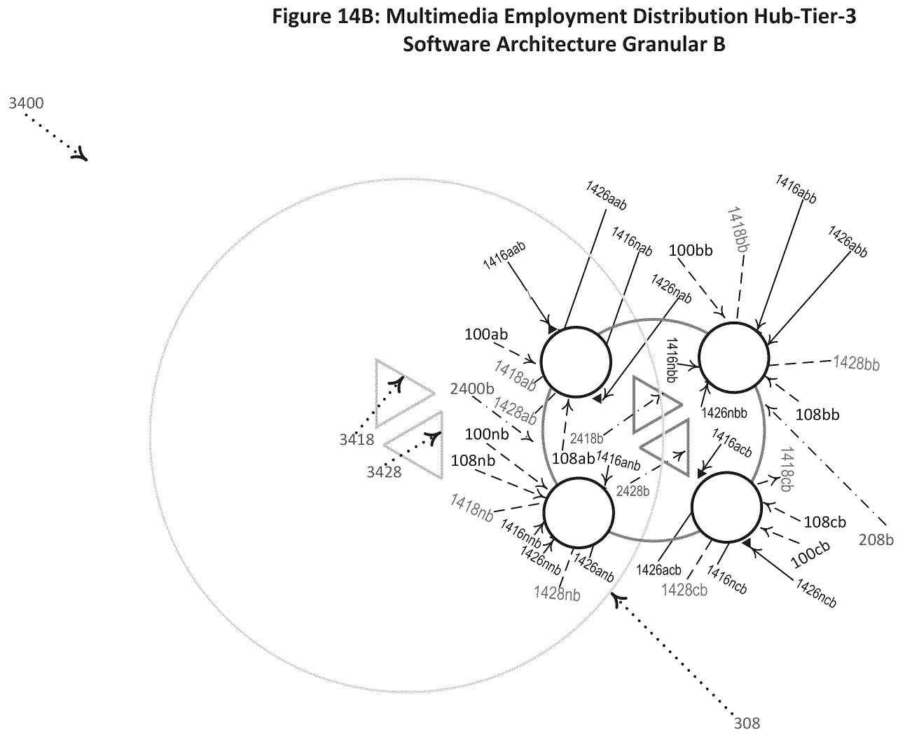

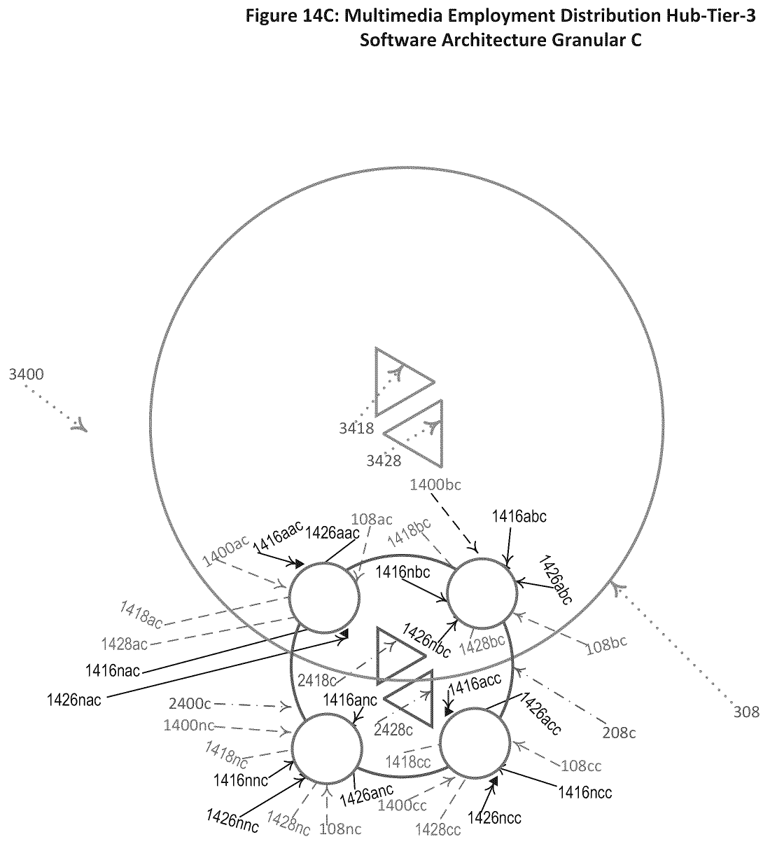

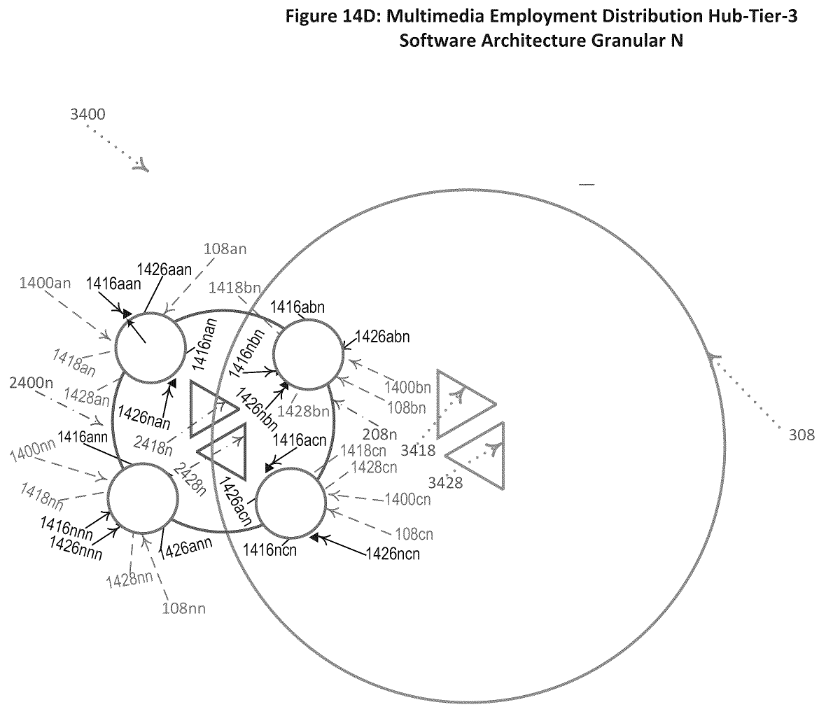

FIG. 14A is a diagram of an example multimedia employment distribution hub tier-3 software architecture illustrating a software application solution, which includes special purpose Software components of a tier-3 multimedia employment distribution hub.

FIG. 14A illustrates an example multimedia employment distribution hub tier-3 software architecture 3400 illustrating a software application Solution, which includes a special purpose software components of a multimedia employment distribution hub tier-3 system. Multimedia employment distribution hub tier-3 software architecture 3400 executes on multimedia employment distribution hub tier-3 hardware architecture 3300. Multimedia employment distribution hub tier-3 software architecture 3400 includes a group of Multimedia employment distribution hub tier-2 software architecture 2400a, a group of Multimedia employment distribution hub tier-1 software architecture 1400aa-1400na, a group of tier-1 outbound employment core applications 1416aaa-1416nna, a group of tier-1 inbound employment core applications 1426aaa-1426nna, a group of tier-2 outbound employment hub applications 2418a, a group of tier-2 inbound employment hub applications 2428a, a group of tier-1 employment hub 108aa-108na, tier-2 employment hub 208a, and tier-3 employment hub 308.

Group of tier-1 outbound employment core applications 1416aaa-1416nna includes integration instructions for controlling communications and represents special purpose media delivery Software applications, which includes delivery instructions for optimal data transfer and protection of data, and comprises: a group of tier-1 outbound relationship core application Software components (which executes on a group of tier-1 outbound relationship core appliances 1306aaa-1306nna respectively); a group of tier-1 outbound security core application Software components (which executes on a group of tier-1 outbound security core appliances 1306aaa-1306nna respectively); a group of tier-1 outbound video content core application software components (which executes on a group of tier-1 outbound video content core appliances 1306aaa-1306nna respectively); a group of tier-1 outbound audio content core application Software components (which executes on a group of tier-1 outbound audio content core appliances 1306aaa-1306nna respectively); a group of tier-1 outbound graphics content core application Software components (which executes on a group of tier-1 outbound graphics content core appliances 1306aaa-1306nna respectively); and a group of tier-1 outbound text content core application software components (which executes on a group of tier-1 outbound text content core appliances 1306aaa-1306nna respectively).

Group of tier-1 inbound employment core applications 1426aaa-1426nna includes integration instructions for controlling communications and represents special purpose media delivery Software applications, which includes delivery instructions for optimal data transfer and protection of data, and comprises: a group of tier-1 inbound relationship core application Software components (which executes on a group of tier-1 inbound relationship core appliances 1306aaa-1306nna respectively); a group of tier-1 inbound security core application Software components (which executes on a group of tier-1 inbound security core appliances 1306aaa-1306nna respectively); a group of tier-1 inbound video content core application software components (which executes on a group of tier-1 inbound video content core appliances 1306aaa-1306nna respectively); a group of tier-1 inbound audio content core application Software components (which executes on a group of tier-1 inbound audio content core appliances 1306aaa-1306nna respectively); a group of tier-1 inbound graphics content core application Software components (which executes on a group of tier-1 inbound graphics content core appliances 1306aaa-1306nna respectively); and a group of tier-1 inbound text content core application software components (which executes on a group of tier-1 inbound text content core appliances 1306aaa-1306nna respectively).

Group of tier-2 outbound employment hub applications 2418a includes integration instructions for controlling communications and represents special purpose media delivery Software applications, which includes delivery instructions for optimal data transfer and protection of data, and comprises: a group of tier-2 outbound relationship hub application Software components (which executes on a group of tier-2 outbound relationship hub appliances 2308a respectively); a group of tier-2 outbound security hub application Software components (which executes on a group of tier-2 outbound security hub appliances 2308a respectively); a group of tier-2 outbound video content hub application software components (which executes on a group of tier-2 outbound video content hub appliances 2308a respectively); a group of tier-2 outbound audio content hub application Software components (which executes on a group of tier-2 outbound audio content hub appliances 2308a respectively); a group of tier-2 outbound graphics content hub application Software components (which executes on a group of tier-2 outbound graphics content hub appliances 2308a respectively); and a group of tier-2 outbound text content hub application software components (which executes on a group of tier-2 outbound text content hub appliances 2308a respectively).

Group of tier-2 inbound employment hub applications 2428a includes integration instructions for controlling communications and represents special purpose media delivery Software applications, which includes delivery instructions for optimal data transfer and protection of data, and comprises: a group of tier-2 inbound relationship hub application Software components (which executes on a group of tier-2 inbound relationship hub appliances 2308a respectively); a group of tier-2 inbound security hub application Software components (which executes on a group of tier-2 inbound security hub appliances 2308a respectively); a group of tier-2 inbound video content hub application software components (which executes on a group of tier-2 inbound video content hub appliances 2308a respectively); a group of tier-2 inbound audio content hub application Software components (which executes on a group of tier-2 inbound audio content hub appliances 2308a respectively); a group of tier-2 inbound graphics content hub application Software components (which executes on a group of tier-2 inbound graphics content hub appliances 2308a respectively); and a group of tier-2 inbound text content hub application software components (which executes on a group of tier-2 inbound text content hub appliances 2308a respectively).

Group of tier-2 outbound employment hub applications 3418 includes integration instructions for controlling communications and represents special purpose media delivery Software applications, which includes delivery instructions for optimal data transfer and protection of data, and comprises: a group of tier-2 outbound relationship hub application Software components (which executes on a group of tier-2 outbound relationship hub appliances 3308); a group of tier-2 outbound security hub application Software components (which executes on a group of tier-2 outbound security hub appliances 3308); a group of tier-2 outbound video content hub application software components (which executes on a group of tier-2 outbound video content hub appliances 3308); a group of tier-2 outbound audio content hub application Software components (which executes on a group of tier-2 outbound audio content hub appliances 3308); a group of tier-2 outbound graphics content hub application Software components (which executes on a group of tier-2 outbound graphics content hub appliances 3308); and a group of tier-2 outbound text content hub application software components (which executes on a group of tier-2 outbound text content hub appliances 3308).

Group of tier-2 inbound employment hub applications 3428 includes integration instructions for controlling communications and represents special purpose media delivery Software applications, which includes delivery instructions for optimal data transfer and protection of data, and comprises: a group of tier-2 inbound relationship hub application Software components (which executes on a group of tier-2 inbound relationship hub appliances 3308); a group of tier-2 inbound security hub application Software components (which executes on a group of tier-2 inbound security hub appliances 3308); a group of tier-2 inbound video content hub application software components (which executes on a group of tier-2 inbound video content hub appliances 3308); a group of tier-2 inbound audio content hub application Software components (which executes on a group of tier-2 inbound audio content hub appliances 3308); a group of tier-2 inbound graphics content hub application Software components (which executes on a group of tier-2 inbound graphics content hub appliances 3308); and a group of tier-2 inbound text content hub application software components (which executes on a group of tier-2 inbound text content hub appliances 3308).

FIG. 12B illustrates an example multimedia employment distribution hub tier-3 hardware architecture 3300 illustrating a hardware based infrastructure solution, which includes special purpose hardware components of a tier-3 multimedia employment distribution hub. A special purpose hardware component system that can be employed in an operating environment and used to host or run a computer application implementing methods of this disclosure (such as method 4500, 4600, etc.), as included on one or more computer readable storage mediums storing computer executable instructions for controlling the computer system, such as a computing device, to perform a process. A computing device typically includes one or more processors and memory. The processors may include two or more processing cores on a chip or two or more processor chips. The computing device can also have one or more additional processing or specialized processors, such as graphics processor for general purpose computing on graphics processor units, to perform processing functions offloaded from the processor. Memory may be arranged in a hierarchy and may include one or more levels of cache. Memory may be volatile (such as random access memory (RAM)), non-volatile (such as read only memory (ROM), flash memory, etc.) or some combination of the two. The computing device can take one or more of several forms. Such forms include a tablet, a personal computer, a workstation, a server, a handheld device, a consumer electronic device, or other, and can be a stand-alone device or configured as part of a computer network, computer cluster, cloud services infrastructure, or other. Computing device may also include additional storage. Storage may be removable and/or non-removable and can include magnetic or optical disks or solid-state memory, or flash storage devices. Computer storage media includes Volatile and non-volatile, removable and non-removable media implemented in any suitable method or technology for storage of information Such as computer readable instructions, data structures, program modules or other data. A propagating signal by itself does not qualify as storage media. Computing device often includes one or more input and/or output connections, such as USB connections, display ports, proprietary connections, and other to connect various devices such as keyboard, pointing device (e.g., mouse), pen, voice input device (e.g. microphone), video camera, touch input device, or other. Output devices may include devices such as a display, speakers, printer, or the like. Computing device often includes one or more communication connections that allow computing device to communicate with other computers/applications. Example communication connections can include, but are not limited to, an Ethernet interface, a wireless interface, a bus interface, a storage area network interface, a proprietary interface. The communication connections can be used to couple the computing device to a computer network, which is a computing devices and possibly other devices interconnected by communications channels that facilitate communications and allows sharing of resources and information among interconnected devices. Examples of computer networks include a local area network, a wide area network, the Internet, or other network. Special purpose media delivery computer systems are optimized for storage and delivery of respective media content, such as video, audio, graphics, and text. Computing device can be configured to run an operating system Software program and one or more computer Software applications, which make up a system platform. A computer Software application configured to execute on the computing device is typically provided as a set of instructions written in a programming language, implementing methods of this disclosure, such as 4500, 4600, etc. A computer application configured to execute on the computing device includes at least one computing process (or computing task), which is an executing program. Each computing process provides the computing resources to execute the program. Multimedia employment distribution hub tier-3 hardware architecture 3300 includes a group of Multimedia employment distribution hub tier-2 hardware architecture 2300b, a group of Multimedia employment distribution hub tier-1 hardware architecture 100ab-100nb, a group of tier-1 employment core appliances 1306aaa-1306nna, a group of tier-1 employment hub appliances 1308ab-1308nb, a group of tier-2 employment hub appliances 2308b, a group of tier-3 employment hub appliances 3308, a group of tier-1 employment hubs 108ab-108nb, and tier-2 employment hub 208b, and tier-3 employment hub 308.

Group of tier-1 employment core appliances 1306aab-1306nnb comprises: a group of tier-1 outbound relationship core appliances; a group of tier-1 outbound security core appliances; a group of tier-1 outbound video content core appliances; a group of tier-1 outbound audio content core appliances; a group of tier-1 outbound graphics content core appliances; a group of tier-1 outbound text content core appliances; a group of tier-1 inbound relationship core appliances; a group of tier-1 inbound security core appliances; a group of tier-1 inbound video content core appliances; a group of tier-1 inbound audio content core appliances; a group of tier-1 inbound graphics content core appliances; a group of tier-1 inbound text content core appliances. Example tier-1 employment core appliances can include a suitable combination of suitable computer servers, such as commodity grade servers, mid-range servers, high end servers, high availability servers, cloud based servers, and data center based servers, in-house servers, and other suitable servers. Employment core appliances can also be housed in a suitable combination of cloud service providers, data center providers, and in-house servers. Tier-1 employment core appliances can provide data backup, data archival, data restore capabilities, physical security, network security, and other suitable server services.

Group of tier-1 employment hub appliances 1308ab-1308nb comprises: a group of tier-1 outbound relationship hub appliances; a group of tier-1 outbound security hub appliances; a group of tier-1 outbound video content hub appliances; a group of tier-1 outbound audio content hub appliances; a group of tier-1 outbound graphics content hub appliances; a group of tier-1 outbound text content hub appliances; a group of tier-1 inbound relationship hub appliances; a group of tier-1 inbound security hub appliances; a group of tier-1 inbound video content hub appliances; a group of tier-1 inbound audio content hub appliances; a group of tier-1 inbound graphics content hub appliances; a group of tier-1 inbound text content hub appliances. Example tier-1 employment hub appliances can include a suitable combination of suitable computer servers, such as commodity grade servers, mid-range servers, high end servers, high availability servers, cloud based servers, and data center based servers, in-house servers, and other suitable servers. Tier-1 Employment hub appliances can also be housed in a suitable combination of cloud service providers, data center providers, and in-house servers. Employment hub appliances can provide data backup, data archival, data restore capabilities, physical security, network security, and other suitable server services.

Group of tier-2 employment hub appliances 2308b comprises: a group of tier-2 outbound relationship hub appliances; a group of tier-2 outbound security hub appliances; a group of tier-2 outbound video content hub appliances; a group of tier-2 outbound audio content hub appliances; a group of tier-2 outbound graphics content hub appliances; a group of tier-2 outbound text content hub appliances; a group of tier-2 inbound relationship hub appliances; a group of tier-2 inbound security hub appliances; a group of tier-2 inbound video content hub appliances; a group of tier-2 inbound audio content hub appliances; a group of tier-2 inbound graphics content hub appliances; a group of tier-2 inbound text content hub appliances. Example tier-2 employment hub appliances can include a suitable combination of suitable computer servers, such as commodity grade servers, mid-range servers, high end servers, high availability servers, cloud based servers, and data center based servers, in-house servers, and other suitable servers. Tier-2 Employment hub appliances can also be housed in a suitable combination of cloud service providers, data center providers, and in-house servers. Employment hub appliances can provide data backup, data archival, data restore capabilities, physical security, network security, and other suitable server services.

FIG. 14B illustrates an example multimedia employment distribution hub tier-3 software architecture 3400 illustrating a software application Solution, which includes a special purpose software components of a multimedia employment distribution hub tier-3 system. Multimedia employment distribution hub tier-3 software architecture 3400 executes on multimedia employment distribution hub tier-3 hardware architecture 3300. Multimedia employment distribution hub tier-3 software architecture 3400 includes a group of Multimedia employment distribution hub tier-2 software architecture 2400b, a group of Multimedia employment distribution hub tier-1 software architecture 1400ab-1400nb, a group of tier-1 outbound employment core applications 1416aab-1416nnb, a group of tier-1 inbound employment core applications 1426aab-1426nnb, a group of tier-2 outbound employment hub applications 2418b, a group of tier-2 inbound employment hub applications 2428b, a group of tier-1 employment hub 108ab-108nb, tier-2 employment hub 208b, and tier-3 employment hub 308.

Group of tier-1 outbound employment core applications 1416aab-1416nnb includes integration instructions for controlling communications and represents special purpose media delivery Software applications, which includes delivery instructions for optimal data transfer and protection of data, and comprises: a group of tier-1 outbound relationship core application Software components (which executes on a group of tier-1 outbound relationship core appliances 1306aab-1306nnb respectively); a group of tier-1 outbound security core application Software components (which executes on a group of tier-1 outbound security core appliances 1306aab-1306nnb respectively); a group of tier-1 outbound video content core application software components (which executes on a group of tier-1 outbound video content core appliances 1306aab-1306nnb respectively); a group of tier-1 outbound audio content core application Software components (which executes on a group of tier-1 outbound audio content core appliances 1306aab-1306nnb respectively); a group of tier-1 outbound graphics content core application Software components (which executes on a group of tier-1 outbound graphics content core appliances 1306aab-1306nnb respectively); and a group of tier-1 outbound text content core application software components (which executes on a group of tier-1 outbound text content core appliances 1306aab-1306nnb respectively).

Group of tier-1 inbound employment core applications 1426aab-1426nnb includes integration instructions for controlling communications and represents special purpose media delivery Software applications, which includes delivery instructions for optimal data transfer and protection of data, and comprises: a group of tier-1 inbound relationship core application Software components (which executes on a group of tier-1 inbound relationship core appliances 1306aab-1306nnb respectively); a group of tier-1 inbound security core application Software components (which executes on a group of tier-1 inbound security core appliances 1306aab-1306nnb respectively); a group of tier-1 inbound video content core application software components (which executes on a group of tier-1 inbound video content core appliances 1306aab-1306nnb respectively); a group of tier-1 inbound audio content core application Software components (which executes on a group of tier-1 inbound audio content core appliances 1306aab-1306nnb respectively); a group of tier-1 inbound graphics content core application Software components (which executes on a group of tier-1 inbound graphics content core appliances 1306aab-1306nnb respectively); and a group of tier-1 inbound text content core application software components (which executes on a group of tier-1 inbound text content core appliances 1306aab-1306nnb respectively).

Group of tier-2 outbound employment hub applications 2418b includes integration instructions for controlling communications and represents special purpose media delivery Software applications, which includes delivery instructions for optimal data transfer and protection of data, and comprises: a group of tier-2 outbound relationship hub application Software components (which executes on a group of tier-2 outbound relationship hub appliances 2308b respectively); a group of tier-2 outbound security hub application Software components (which executes on a group of tier-2 outbound security hub appliances 2308b respectively); a group of tier-2 outbound video content hub application software components (which executes on a group of tier-2 outbound video content hub appliances 2308b respectively); a group of tier-2 outbound audio content hub application Software components (which executes on a group of tier-2 outbound audio content hub appliances 2308b respectively); a group of tier-2 outbound graphics content hub application Software components (which executes on a group of tier-2 outbound graphics content hub appliances 2308b respectively); and a group of tier-2 outbound text content hub application software components (which executes on a group of tier-2 outbound text content hub appliances 2308b respectively).

Group of tier-2 inbound employment hub applications 2428b includes integration instructions for controlling communications and represents special purpose media delivery Software applications, which includes delivery instructions for optimal data transfer and protection of data, and comprises: a group of tier-2 inbound relationship hub application Software components (which executes on a group of tier-2 inbound relationship hub appliances 2308b respectively); a group of tier-2 inbound security hub application Software components (which executes on a group of tier-2 inbound security hub appliances 2308b respectively); a group of tier-2 inbound video content hub application software components (which executes on a group of tier-2 inbound video content hub appliances 2308b respectively); a group of tier-2 inbound audio content hub application Software components (which executes on a group of tier-2 inbound audio content hub appliances 2308b respectively); a group of tier-2 inbound graphics content hub application Software components (which executes on a group of tier-2 inbound graphics content hub appliances 2308b respectively); and a group of tier-2 inbound text content hub application software components (which executes on a group of tier-2 inbound text content hub appliances 2308b respectively).

Group of tier-2 outbound employment hub applications 3418 includes integration instructions for controlling communications and represents special purpose media delivery Software applications, which includes delivery instructions for optimal data transfer and protection of data, and comprises: a group of tier-2 outbound relationship hub application Software components (which executes on a group of tier-2 outbound relationship hub appliances 3308); a group of tier-2 outbound security hub application Software components (which executes on a group of tier-2 outbound security hub appliances 3308); a group of tier-2 outbound video content hub application software components (which executes on a group of tier-2 outbound video content hub appliances 3308); a group of tier-2 outbound audio content hub application Software components (which executes on a group of tier-2 outbound audio content hub appliances 3308); a group of tier-2 outbound graphics content hub application Software components (which executes on a group of tier-2 outbound graphics content hub appliances 3308); and a group of tier-2 outbound text content hub application software components (which executes on a group of tier-2 outbound text content hub appliances 3308).

Group of tier-2 inbound employment hub applications 3428 includes integration instructions for controlling communications and represents special purpose media delivery Software applications, which includes delivery instructions for optimal data transfer and protection of data, and comprises: a group of tier-2 inbound relationship hub application Software components (which executes on a group of tier-2 inbound relationship hub appliances 3308); a group of tier-2 inbound security hub application Software components (which executes on a group of tier-2 inbound security hub appliances 3308); a group of tier-2 inbound video content hub application software components (which executes on a group of tier-2 inbound video content hub appliances 3308); a group of tier-2 inbound audio content hub application Software components (which executes on a group of tier-2 inbound audio content hub appliances 3308); a group of tier-2 inbound graphics content hub application Software components (which executes on a group of tier-2 inbound graphics content hub appliances 3308); and a group of tier-2 inbound text content hub application software components (which executes on a group of tier-2 inbound text content hub appliances 3308).

FIG. 12C illustrates an example multimedia employment distribution hub tier-3 hardware architecture 3300 illustrating a hardware based infrastructure solution, which includes special purpose hardware components of a tier-3 multimedia employment distribution hub. A special purpose hardware component system that can be employed in an operating environment and used to host or run a computer application implementing methods of this disclosure (such as method 4500, 4600, etc.), as included on one or more computer readable storage mediums storing computer executable instructions for controlling the computer system, such as a computing device, to perform a process. A computing device typically includes one or more processors and memory. The processors may include two or more processing cores on a chip or two or more processor chips. The computing device can also have one or more additional processing or specialized processors, such as graphics processor for general purpose computing on graphics processor units, to perform processing functions offloaded from the processor. Memory may be arranged in a hierarchy and may include one or more levels of cache. Memory may be volatile (such as random access memory (RAM)), non-volatile (such as read only memory (ROM), flash memory, etc.) or some combination of the two. The computing device can take one or more of several forms. Such forms include a tablet, a personal computer, a workstation, a server, a handheld device, a consumer electronic device, or other, and can be a stand-alone device or configured as part of a computer network, computer cluster, cloud services infrastructure, or other. Computing device may also include additional storage. Storage may be removable and/or non-removable and can include magnetic or optical disks or solid-state memory, or flash storage devices. Computer storage media includes Volatile and non-volatile, removable and non-removable media implemented in any suitable method or technology for storage of information Such as computer readable instructions, data structures, program modules or other data. A propagating signal by itself does not qualify as storage media. Computing device often includes one or more input and/or output connections, such as USB connections, display ports, proprietary connections, and other to connect various devices such as keyboard, pointing device (e.g., mouse), pen, voice input device (e.g. microphone), video camera, touch input device, or other. Output devices may include devices such as a display, speakers, printer, or the like. Computing device often includes one or more communication connections that allow computing device to communicate with other computers/applications. Example communication connections can include, but are not limited to, an Ethernet interface, a wireless interface, a bus interface, a storage area network interface, a proprietary interface. The communication connections can be used to couple the computing device to a computer network, which is a computing devices and possibly other devices interconnected by communications channels that facilitate communications and allows sharing of resources and information among interconnected devices. Examples of computer networks include a local area network, a wide area network, the Internet, or other network. Special purpose media delivery computer systems are optimized for storage and delivery of respective media content, such as video, audio, graphics, and text. Computing device can be configured to run an operating system Software program and one or more computer Software applications, which make up a system platform. A computer Software application configured to execute on the computing device is typically provided as a set of instructions written in a programming language, implementing methods of this disclosure, such as 4500, 4600, etc. A computer application configured to execute on the computing device includes at least one computing process (or computing task), which is an executing program. Each computing process provides the computing resources to execute the program. Multimedia employment distribution hub tier-3 hardware architecture 3300 includes a group of Multimedia employment distribution hub tier-2 hardware architecture 2300c, a group of Multimedia employment distribution hub tier-1 hardware architecture 100ac-100nc, a group of tier-1 employment core appliances 1306aac-1306nnc, a group of tier-1 employment hub appliances 1308ac-1308nc, a group of tier-2 employment hub appliances 2308c, a group of tier-3 employment hub appliances 3308, a group of tier-1 employment hubs 108ac-108nc, and tier-2 employment hub 208c, and tier-3 employment hub 308.

Group of tier-1 employment core appliances 1306aac-1306nnc comprises: a group of tier-1 outbound relationship core appliances; a group of tier-1 outbound security core appliances; a group of tier-1 outbound video content core appliances; a group of tier-1 outbound audio content core appliances; a group of tier-1 outbound graphics content core appliances; a group of tier-1 outbound text content core appliances; a group of tier-1 inbound relationship core appliances; a group of tier-1 inbound security core appliances; a group of tier-1 inbound video content core appliances; a group of tier-1 inbound audio content core appliances; a group of tier-1 inbound graphics content core appliances; a group of tier-1 inbound text content core appliances. Example tier-1 employment core appliances can include a suitable combination of suitable computer servers, such as commodity grade servers, mid-range servers, high end servers, high availability servers, cloud based servers, and data center based servers, in-house servers, and other suitable servers. Employment core appliances can also be housed in a suitable combination of cloud service providers, data center providers, and in-house servers. Tier-1 employment core appliances can provide data backup, data archival, data restore capabilities, physical security, network security, and other suitable server services.

Group of tier-1 employment hub appliances 1308ac-1308nc comprises: a group of tier-1 outbound relationship hub appliances; a group of tier-1 outbound security hub appliances; a group of tier-1 outbound video content hub appliances; a group of tier-1 outbound audio content hub appliances; a group of tier-1 outbound graphics content hub appliances; a group of tier-1 outbound text content hub appliances; a group of tier-1 inbound relationship hub appliances; a group of tier-1 inbound security hub appliances; a group of tier-1 inbound video content hub appliances; a group of tier-1 inbound audio content hub appliances; a group of tier-1 inbound graphics content hub appliances; a group of tier-1 inbound text content hub appliances. Example tier-1 employment hub appliances can include a suitable combination of suitable computer servers, such as commodity grade servers, mid-range servers, high end servers, high availability servers, cloud based servers, and data center based servers, in-house servers, and other suitable servers. Tier-1 Employment hub appliances can also be housed in a suitable combination of cloud service providers, data center providers, and in-house servers. Employment hub appliances can provide data backup, data archival, data restore capabilities, physical security, network security, and other suitable server services.

Group of tier-2 employment hub appliances 2308c comprises: a group of tier-2 outbound relationship hub appliances; a group of tier-2 outbound security hub appliances; a group of tier-2 outbound video content hub appliances; a group of tier-2 outbound audio content hub appliances; a group of tier-2 outbound graphics content hub appliances; a group of tier-2 outbound text content hub appliances; a group of tier-2 inbound relationship hub appliances; a group of tier-2 inbound security hub appliances; a group of tier-2 inbound video content hub appliances; a group of tier-2 inbound audio content hub appliances; a group of tier-2 inbound graphics content hub appliances; a group of tier-2 inbound text content hub appliances. Example tier-2 employment hub appliances can include a suitable combination of suitable computer servers, such as commodity grade servers, mid-range servers, high end servers, high availability servers, cloud based servers, and data center based servers, in-house servers, and other suitable servers. Tier-2 Employment hub appliances can also be housed in a suitable combination of cloud service providers, data center providers, and in-house servers. Employment hub appliances can provide data backup, data archival, data restore capabilities, physical security, network security, and other suitable server services.

FIG. 14C illustrates an example multimedia employment distribution hub tier-3 software architecture 3400 illustrating a software application Solution, which includes a special purpose software components of a multimedia employment distribution hub tier-3 system. Multimedia employment distribution hub tier-3 software architecture 3400 executes on multimedia employment distribution hub tier-3 hardware architecture 3300. Multimedia employment distribution hub tier-3 software architecture 3400 includes a group of Multimedia employment distribution hub tier-2 software architecture 2400c, a group of Multimedia employment distribution hub tier-1 software architecture 1400ac-1400nc, a group of tier-1 outbound employment core applications 1416aac-1416nnc, a group of tier-1 inbound employment core applications 1426aac-1426nnc, a group of tier-2 outbound employment hub applications 2418c, a group of tier-2 inbound employment hub applications 2428c, a group of tier-1 employment hub 108ac-108nc, tier-2 employment hub 208c, and tier-3 employment hub 308.

Group of tier-1 outbound employment core applications 1416aac-1416nnc includes integration instructions for controlling communications and represents special purpose media delivery Software applications, which includes delivery instructions for optimal data transfer and protection of data, and comprises: a group of tier-1 outbound relationship core application Software components (which executes on a group of tier-1 outbound relationship core appliances 1306aac-1306nnc respectively); a group of tier-1 outbound security core application Software components (which executes on a group of tier-1 outbound security core appliances 1306aac-1306nnc respectively); a group of tier-1 outbound video content core application software components (which executes on a group of tier-1 outbound video content core appliances 1306aac-1306nnc respectively); a group of tier-1 outbound audio content core application Software components (which executes on a group of tier-1 outbound audio content core appliances 1306aac-1306nnc respectively); a group of tier-1 outbound graphics content core application Software components (which executes on a group of tier-1 outbound graphics content core appliances 1306aac-1306nnc respectively); and a group of tier-1 outbound text content core application software components (which executes on a group of tier-1 outbound text content core appliances 1306aac-1306nnc respectively).

Group of tier-1 inbound employment core applications 1426aac-1426nnc includes integration instructions for controlling communications and represents special purpose media delivery Software applications, which includes delivery instructions for optimal data transfer and protection of data, and comprises: a group of tier-1 inbound relationship core application Software components (which executes on a group of tier-1 inbound relationship core appliances 1306aac-1306nnc respectively); a group of tier-1 inbound security core application Software components (which executes on a group of tier-1 inbound security core appliances 1306aac-1306nnc respectively); a group of tier-1 inbound video content core application software components (which executes on a group of tier-1 inbound video content core appliances 1306aac-1306nnc respectively); a group of tier-1 inbound audio content core application Software components (which executes on a group of tier-1 inbound audio content core appliances 1306aac-1306nnc respectively); a group of tier-1 inbound graphics content core application Software components (which executes on a group of tier-1 inbound graphics content core appliances 1306aac-1306nnc respectively); and a group of tier-1 inbound text content core application software components (which executes on a group of tier-1 inbound text content core appliances 1306aac-1306nnc respectively).

Group of tier-2 outbound employment hub applications 2418c includes integration instructions for controlling communications and represents special purpose media delivery Software applications, which includes delivery instructions for optimal data transfer and protection of data, and comprises: a group of tier-2 outbound relationship hub application Software components (which executes on a group of tier-2 outbound relationship hub appliances 2308c respectively); a group of tier-2 outbound security hub application Software components (which executes on a group of tier-2 outbound security hub appliances 2308c respectively); a group of tier-2 outbound video content hub application software components (which executes on a group of tier-2 outbound video content hub appliances 2308c respectively); a group of tier-2 outbound audio content hub application Software components (which executes on a group of tier-2 outbound audio content hub appliances 2308c respectively); a group of tier-2 outbound graphics content hub application Software components (which executes on a group of tier-2 outbound graphics content hub appliances 2308c respectively); and a group of tier-2 outbound text content hub application software components (which executes on a group of tier-2 outbound text content hub appliances 2308c respectively).

Group of tier-2 inbound employment hub applications 2428c includes integration instructions for controlling communications and represents special purpose media delivery Software applications, which includes delivery instructions for optimal data transfer and protection of data, and comprises: a group of tier-2 inbound relationship hub application Software components (which executes on a group of tier-2 inbound relationship hub appliances 2308c respectively); a group of tier-2 inbound security hub application Software components (which executes on a group of tier-2 inbound security hub appliances 2308c respectively); a group of tier-2 inbound video content hub application software components (which executes on a group of tier-2 inbound video content hub appliances 2308c respectively); a group of tier-2 inbound audio content hub application Software components (which executes on a group of tier-2 inbound audio content hub appliances 2308c respectively); a group of tier-2 inbound graphics content hub application Software components (which executes on a group of tier-2 inbound graphics content hub appliances 2308c respectively); and a group of tier-2 inbound text content hub application software components (which executes on a group of tier-2 inbound text content hub appliances 2308c respectively).

Group of tier-2 outbound employment hub applications 3418 includes integration instructions for controlling communications and represents special purpose media delivery Software applications, which includes delivery instructions for optimal data transfer and protection of data, and comprises: a group of tier-2 outbound relationship hub application Software components (which executes on a group of tier-2 outbound relationship hub appliances 3308); a group of tier-2 outbound security hub application Software components (which executes on a group of tier-2 outbound security hub appliances 3308); a group of tier-2 outbound video content hub application software components (which executes on a group of tier-2 outbound video content hub appliances 3308); a group of tier-2 outbound audio content hub application Software components (which executes on a group of tier-2 outbound audio content hub appliances 3308); a group of tier-2 outbound graphics content hub application Software components (which executes on a group of tier-2 outbound graphics content hub appliances 3308); and a group of tier-2 outbound text content hub application software components (which executes on a group of tier-2 outbound text content hub appliances 3308).

Group of tier-2 inbound employment hub applications 3428 includes integration instructions for controlling communications and represents special purpose media delivery Software applications, which includes delivery instructions for optimal data transfer and protection of data, and comprises: a group of tier-2 inbound relationship hub application Software components (which executes on a group of tier-2 inbound relationship hub appliances 3308); a group of tier-2 inbound security hub application Software components (which executes on a group of tier-2 inbound security hub appliances 3308); a group of tier-2 inbound video content hub application software components (which executes on a group of tier-2 inbound video content hub appliances 3308); a group of tier-2 inbound audio content hub application Software components (which executes on a group of tier-2 inbound audio content hub appliances 3308); a group of tier-2 inbound graphics content hub application Software components (which executes on a group of tier-2 inbound graphics content hub appliances 3308); and a group of tier-2 inbound text content hub application software components (which executes on a group of tier-2 inbound text content hub appliances 3308).

FIG. 12D illustrates an example multimedia employment distribution hub tier-3 hardware architecture 3300 illustrating a hardware based infrastructure solution, which includes special purpose hardware components of a tier-3 multimedia employment distribution hub. A special purpose hardware component system that can be employed in an operating environment and used to host or run a computer application implementing methods of this disclosure (such as method 4500, 4600, etc.), as included on one or more computer readable storage mediums storing computer executable instructions for controlling the computer system, such as a computing device, to perform a process. A computing device typically includes one or more processors and memory. The processors may include two or more processing cores on a chip or two or more processor chips. The computing device can also have one or more additional processing or specialized processors, such as graphics processor for general purpose computing on graphics processor units, to perform processing functions offloaded from the processor. Memory may be arranged in a hierarchy and may include one or more levels of cache. Memory may be volatile (such as random access memory (RAM)), non-volatile (such as read only memory (ROM), flash memory, etc.) or some combination of the two. The computing device can take one or more of several forms. Such forms include a tablet, a personal computer, a workstation, a server, a handheld device, a consumer electronic device, or other, and can be a stand-alone device or configured as part of a computer network, computer cluster, cloud services infrastructure, or other. Computing device may also include additional storage. Storage may be removable and/or non-removable and can include magnetic or optical disks or solid-state memory, or flash storage devices. Computer storage media includes Volatile and non-volatile, removable and non-removable media implemented in any suitable method or technology for storage of information Such as computer readable instructions, data structures, program modules or other data. A propagating signal by itself does not qualify as storage media. Computing device often includes one or more input and/or output connections, such as USB connections, display ports, proprietary connections, and other to connect various devices such as keyboard, pointing device (e.g., mouse), pen, voice input device (e.g. microphone), video camera, touch input device, or other. Output devices may include devices such as a display, speakers, printer, or the like. Computing device often includes one or more communication connections that allow computing device to communicate with other computers/applications. Example communication connections can include, but are not limited to, an Ethernet interface, a wireless interface, a bus interface, a storage area network interface, a proprietary interface. The communication connections can be used to couple the computing device to a computer network, which is a computing devices and possibly other devices interconnected by communications channels that facilitate communications and allows sharing of resources and information among interconnected devices. Examples of computer networks include a local area network, a wide area network, the Internet, or other network. Special purpose media delivery computer systems are optimized for storage and delivery of respective media content, such as video, audio, graphics, and text. Computing device can be configured to run an operating system Software program and one or more computer Software applications, which make up a system platform. A computer Software application configured to execute on the computing device is typically provided as a set of instructions written in a programming language, implementing methods of this disclosure, such as 4500, 4600, etc. A computer application configured to execute on the computing device includes at least one computing process (or computing task), which is an executing program. Each computing process provides the computing resources to execute the program. Multimedia employment distribution hub tier-3 hardware architecture 3300 includes a group of Multimedia employment distribution hub tier-2 hardware architecture 2300n, a group of Multimedia employment distribution hub tier-1 hardware architecture 100an-100nn, a group of tier-1 employment core appliances 1306aan-1306nnn, a group of tier-1 employment hub appliances 1308an-1308nn, a group of tier-2 employment hub appliances 2308n, a group of tier-3 employment hub appliances 3308, a group of tier-1 employment hubs 108an-108nn, and tier-2 employment hub 208n, and tier-3 employment hub 308.

Group of tier-1 employment core appliances 1306aan-1306nnn comprises: a group of tier-1 outbound relationship core appliances; a group of tier-1 outbound security core appliances; a group of tier-1 outbound video content core appliances; a group of tier-1 outbound audio content core appliances; a group of tier-1 outbound graphics content core appliances; a group of tier-1 outbound text content core appliances; a group of tier-1 inbound relationship core appliances; a group of tier-1 inbound security core appliances; a group of tier-1 inbound video content core appliances; a group of tier-1 inbound audio content core appliances; a group of tier-1 inbound graphics content core appliances; a group of tier-1 inbound text content core appliances. Example tier-1 employment core appliances can include a suitable combination of suitable computer servers, such as commodity grade servers, mid-range servers, high end servers, high availability servers, cloud based servers, and data center based servers, in-house servers, and other suitable servers. Employment core appliances can also be housed in a suitable combination of cloud service providers, data center providers, and in-house servers. Tier-1 employment core appliances can provide data backup, data archival, data restore capabilities, physical security, network security, and other suitable server services.

Group of tier-1 employment hub appliances 1308an-1308nn comprises: a group of tier-1 outbound relationship hub appliances; a group of tier-1 outbound security hub appliances; a group of tier-1 outbound video content hub appliances; a group of tier-1 outbound audio content hub appliances; a group of tier-1 outbound graphics content hub appliances; a group of tier-1 outbound text content hub appliances; a group of tier-1 inbound relationship hub appliances; a group of tier-1 inbound security hub appliances; a group of tier-1 inbound video content hub appliances; a group of tier-1 inbound audio content hub appliances; a group of tier-1 inbound graphics content hub appliances; a group of tier-1 inbound text content hub appliances. Example tier-1 employment hub appliances can include a suitable combination of suitable computer servers, such as commodity grade servers, mid-range servers, high end servers, high availability servers, cloud based servers, and data center based servers, in-house servers, and other suitable servers. Tier-1 Employment hub appliances can also be housed in a suitable combination of cloud service providers, data center providers, and in-house servers. Employment hub appliances can provide data backup, data archival, data restore capabilities, physical security, network security, and other suitable server services.

Group of tier-2 employment hub appliances 2308n comprises: a group of tier-2 outbound relationship hub appliances; a group of tier-2 outbound security hub appliances; a group of tier-2 outbound video content hub appliances; a group of tier-2 outbound audio content hub appliances; a group of tier-2 outbound graphics content hub appliances; a group of tier-2 outbound text content hub appliances; a group of tier-2 inbound relationship hub appliances; a group of tier-2 inbound security hub appliances; a group of tier-2 inbound video content hub appliances; a group of tier-2 inbound audio content hub appliances; a group of tier-2 inbound graphics content hub appliances; a group of tier-2 inbound text content hub appliances. Example tier-2 employment hub appliances can include a suitable combination of suitable computer servers, such as commodity grade servers, mid-range servers, high end servers, high availability servers, cloud based servers, and data center based servers, in-house servers, and other suitable servers. Tier-2 Employment hub appliances can also be housed in a suitable combination of cloud service providers, data center providers, and in-house servers. Employment hub appliances can provide data backup, data archival, data restore capabilities, physical security, network security, and other suitable server services.

FIG. 14D illustrates an example multimedia employment distribution hub tier-3 software architecture 3400 illustrating a software application Solution, which includes a special purpose software components of a multimedia employment distribution hub tier-3 system. Multimedia employment distribution hub tier-3 software architecture 3400 executes on multimedia employment distribution hub tier-3 hardware architecture 3300. Multimedia employment distribution hub tier-3 software architecture 3400 includes a group of Multimedia employment distribution hub tier-2 software architecture 2400n, a group of Multimedia employment distribution hub tier-1 software architecture 1400an-1400nn, a group of tier-1 outbound employment core applications 1416aan-1416nnn, a group of tier-1 inbound employment core applications 1426aan-1426nnn, a group of tier-2 outbound employment hub applications 2418n, a group of tier-2 inbound employment hub applications 2428n, a group of tier-1 employment hub 108an-108nn, tier-2 employment hub 208n, and tier-3 employment hub 308.

Group of tier-1 outbound employment core applications 1416aan-1416nnn includes integration instructions for controlling communications and represents special purpose media delivery Software applications, which includes delivery instructions for optimal data transfer and protection of data, and comprises: a group of tier-1 outbound relationship core application Software components (which executes on a group of tier-1 outbound relationship core appliances 1306aan-1306nnn respectively); a group of tier-1 outbound security core application Software components (which executes on a group of tier-1 outbound security core appliances 1306aan-1306nnn respectively); a group of tier-1 outbound video content core application software components (which executes on a group of tier-1 outbound video content core appliances 1306aan-1306nnn respectively); a group of tier-1 outbound audio content core application Software components (which executes on a group of tier-1 outbound audio content core appliances 1306aan-1306nnn respectively); a group of tier-1 outbound graphics content core application Software components (which executes on a group of tier-1 outbound graphics content core appliances 1306aan-1306nnn respectively); and a group of tier-1 outbound text content core application software components (which executes on a group of tier-1 outbound text content core appliances 1306aan-1306nnn respectively).

Group of tier-1 inbound employment core applications 1426aan-1426nnn includes integration instructions for controlling communications and represents special purpose media delivery Software applications, which includes delivery instructions for optimal data transfer and protection of data, and comprises: a group of tier-1 inbound relationship core application Software components (which executes on a group of tier-1 inbound relationship core appliances 1306aan-1306nnn respectively); a group of tier-1 inbound security core application Software components (which executes on a group of tier-1 inbound security core appliances 1306aan-1306nnn respectively); a group of tier-1 inbound video content core application software components (which executes on a group of tier-1 inbound video content core appliances 1306aan-1306nnn respectively); a group of tier-1 inbound audio content core application Software components (which executes on a group of tier-1 inbound audio content core appliances 1306aan-1306nnn respectively); a group of tier-1 inbound graphics content core application Software components (which executes on a group of tier-1 inbound graphics content core appliances 1306aan-1306nnn respectively); and a group of tier-1 inbound text content core application software components (which executes on a group of tier-1 inbound text content core appliances 1306aan-1306nnn respectively).

Group of tier-2 outbound employment hub applications 2418n includes integration instructions for controlling communications and represents special purpose media delivery Software applications, which includes delivery instructions for optimal data transfer and protection of data, and comprises: a group of tier-2 outbound relationship hub application Software components (which executes on a group of tier-2 outbound relationship hub appliances 2308n respectively); a group of tier-2 outbound security hub application Software components (which executes on a group of tier-2 outbound security hub appliances 2308n respectively); a group of tier-2 outbound video content hub application software components (which executes on a group of tier-2 outbound video content hub appliances 2308n respectively); a group of tier-2 outbound audio content hub application Software components (which executes on a group of tier-2 outbound audio content hub appliances 2308n respectively); a group of tier-2 outbound graphics content hub application Software components (which executes on a group of tier-2 outbound graphics content hub appliances 2308n respectively); and a group of tier-2 outbound text content hub application software components (which executes on a group of tier-2 outbound text content hub appliances 2308n respectively).

Group of tier-2 inbound employment hub applications 2428n includes integration instructions for controlling communications and represents special purpose media delivery Software applications, which includes delivery instructions for optimal data transfer and protection of data, and comprises: a group of tier-2 inbound relationship hub application Software components (which executes on a group of tier-2 inbound relationship hub appliances 2308n respectively); a group of tier-2 inbound security hub application Software components (which executes on a group of tier-2 inbound security hub appliances 2308n respectively); a group of tier-2 inbound video content hub application software components (which executes on a group of tier-2 inbound video content hub appliances 2308n respectively); a group of tier-2 inbound audio content hub application Software components (which executes on a group of tier-2 inbound audio content hub appliances 2308n respectively); a group of tier-2 inbound graphics content hub application Software components (which executes on a group of tier-2 inbound graphics content hub appliances 2308n respectively); and a group of tier-2 inbound text content hub application software components (which executes on a group of tier-2 inbound text content hub appliances 2308n respectively).

Group of staffing core applications 446 includes integration instructions for controlling communications and represents special purpose media delivery Software applications, which includes delivery instructions for optimal data transfer and protection of data, and comprises: a group of relationship core application Software components 448 (which executes on a group of relationship core appliances 348); a group of security core application Software components 450 (which executes on a group of security core appliances 350); a group of video content core application software components 452 (which executes on a group of video content core appliances 352); a group of audio content core application Software components 454 (which executes on a group of audio content core appliances 354); a group of graphics content core application Software components 456 (which executes on a group of graphics content core appliances 356); and a group of text content core application software components 458 (which executes on a group of text content core appliances 358).

Group of employment core applications 446 includes integration instructions for controlling communications and represents special purpose media delivery Software applications, which includes delivery instructions for optimal data transfer and protection of data, and comprises: a group of relationship core application Software components 448 (which executes on a group of relationship core appliances 348); a group of security core application Software components 450 (which executes on a group of security core appliances 350); a group of video content core application software components 452 (which executes on a group of video content core appliances 352); a group of audio content core application Software components 454 (which executes on a group of audio content core appliances 354); a group of graphics content core application Software components 456 (which executes on a group of graphics content core appliances 356); and a group of text content core application software components 458 (which executes on a group of text content core appliances 358); and a group of virtual reality content core application software components 460 (which executes on a group of virtual reality content core appliances 360); and a group of augmented reality content core application software components 462 (which executes on a group of augmented reality content core appliances 362).

Group of tier-2 outbound employment hub applications 3418 includes integration instructions for controlling communications and represents special purpose media delivery Software applications, which includes delivery instructions for optimal data transfer and protection of data, and comprises: a group of tier-2 outbound relationship hub application Software components (which executes on a group of tier-2 outbound relationship hub appliances 3308); a group of tier-2 outbound security hub application Software components (which executes on a group of tier-2 outbound security hub appliances 3308); a group of tier-2 outbound video content hub application software components (which executes on a group of tier-2 outbound video content hub appliances 3308); a group of tier-2 outbound audio content hub application Software components (which executes on a group of tier-2 outbound audio content hub appliances 3308); a group of tier-2 outbound graphics content hub application Software components (which executes on a group of tier-2 outbound graphics content hub appliances 3308); and a group of tier-2 outbound text content hub application software components (which executes on a group of tier-2 outbound text content hub appliances 3308).

Group of tier-2 inbound employment hub applications 3428 includes integration instructions for controlling communications and represents special purpose media delivery Software applications, which includes delivery instructions for optimal data transfer and protection of data, and comprises: a group of tier-2 inbound relationship hub application Software components (which executes on a group of tier-2 inbound relationship hub appliances 3308); a group of tier-2 inbound security hub application Software components (which executes on a group of tier-2 inbound security hub appliances 3308); a group of tier-2 inbound video content hub application software components (which executes on a group of tier-2 inbound video content hub appliances 3308); a group of tier-2 inbound audio content hub application Software components (which executes on a group of tier-2 inbound audio content hub appliances 3308); a group of tier-2 inbound graphics content hub application Software components (which executes on a group of tier-2 inbound graphics content hub appliances 3308); and a group of tier-2 inbound text content hub application software components (which executes on a group of tier-2 inbound text content hub appliances 3308).

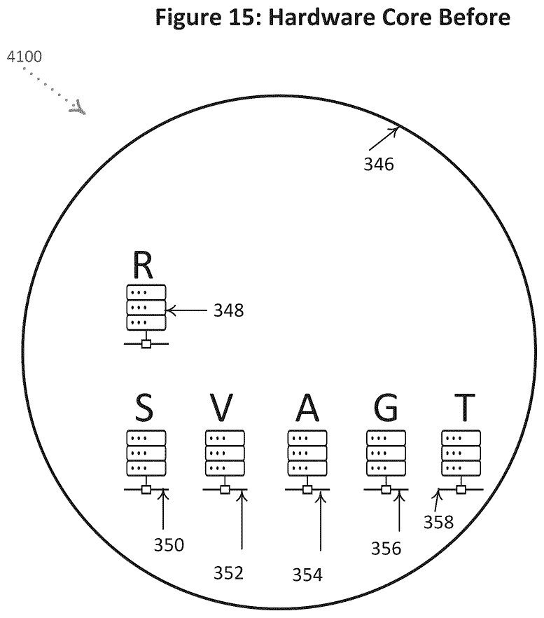

FIG. 15 illustrates an example multimedia employment distribution hardware architecture Before 4100 illustrating a hardware based employment infrastructure solution, which includes special purpose hardware components of a multimedia employment distribution system. A special purpose hardware component system that can be employed in an operating environment and used to host or run a computer application implementing methods of this disclosure (such as method 4500, 4600, etc.), as included on one or more computer readable storage mediums storing computer executable instructions for controlling the computer system, such as a computing device, to perform a process. A computing device typically includes one or more processors and memory. The processors may include two or more processing cores on a chip or two or more processor chips. The computing device can also have one or more additional processing or specialized processors, such as graphics processor for general purpose computing on graphics processor units, to perform processing functions offloaded from the processor. Memory may be arranged in a hierarchy and may include one or more levels of cache. Memory may be volatile (such as random access memory (RAM)), non-volatile (such as read only memory (ROM), flash memory, etc.) or some combination of the two. The computing device can take one or more of several forms. Such forms include a tablet, a personal computer, a workstation, a server, a handheld device, a consumer electronic device, or other, and can be a stand-alone device or configured as part of a computer network, computer cluster, cloud services infrastructure, or other. Computing device may also include additional storage. Storage may be removable and/or non-removable and can include magnetic or optical disks or solid-state memory, or flash storage devices. Computer storage media includes Volatile and non-volatile, removable and non-removable media implemented in any suitable method or technology for storage of information Such as computer readable instructions, data structures, program modules or other data. A propagating signal by itself does not qualify as storage media. Computing device often includes one or more input and/or output connections, such as USB connections, display ports, proprietary connections, and other to connect various devices such as keyboard, pointing device (e.g., mouse), pen, voice input device (e.g. microphone), video camera, touch input device, or other. Output devices may include devices such as a display, speakers, printer, or the like. Computing device often includes one or more communication connections that allow computing device to communicate with other computers/applications. Example communication connections can include, but are not limited to, an Ethernet interface, a wireless interface, a bus interface, a storage area network interface, a proprietary interface. The communication connections can be used to couple the computing device to a computer network, which is a computing devices and possibly other devices interconnected by communications channels that facilitate communications and allows sharing of resources and information among interconnected devices. Examples of computer networks include a local area network, a wide area network, the Internet, or other network. Special purpose media delivery computer systems are optimized for storage and delivery of respective media content, such as video, audio, graphics, virtual reality, augmented reality, and text. Computing device can be configured to run an operating system Software program and one or more computer Software applications, which make up a system platform. A computer Software application configured to execute on the computing device is typically provided as a set of instructions written in a programming language, implementing methods of this disclosure, such 4500, 4600, etc. A computer application configured to execute on the computing device includes at least one computing process (or computing task), which is an executing program. Each computing process provides the computing resources to execute the program. Multimedia employment distribution hardware architecture 4100 includes a group of employment core appliances 346.

Group of employment core appliances 346 comprises: a group of relationship core appliances 348; a group of security core appliances 350; a group of video content core appliances 352; a group of audio content core appliances 354; a group of graphics content core appliances 356; a group of text content core appliances 358. Example employment core appliances 346 can include a suitable combination of suitable computer Servers. Such as commodity grade servers, mid-range servers, high end servers, high availability servers, cloud based servers, and data center based servers, in-house server, and other suitable servers. Employment core appliances 346 can also be housed in a suitable combination of cloud service providers, data center providers, and in-house servers. Employment core appliances 346 can provide data backup, data archival, data restore capabilities, physical security, network security, and other suitable server services.

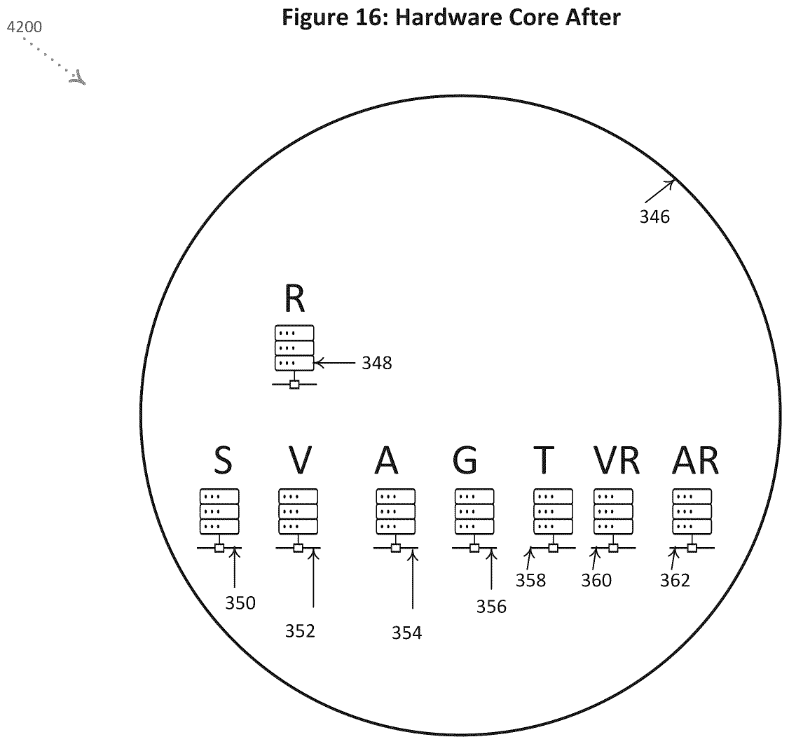

FIG. 16 illustrates an example multimedia employment distribution hardware architecture After 4200 illustrating a hardware based employment infrastructure solution, which includes special purpose hardware components of a multimedia employment distribution system. A special purpose hardware component system that can be employed in an operating environment and used to host or run a computer application implementing methods of this disclosure (such as method 4500, 4600, etc.), as included on one or more computer readable storage mediums storing computer executable instructions for controlling the computer system, such as a computing device, to perform a process. A computing device typically includes one or more processors and memory. The processors may include two or more processing cores on a chip or two or more processor chips. The computing device can also have one or more additional processing or specialized processors, such as graphics processor for general purpose computing on graphics processor units, to perform processing functions offloaded from the processor. Memory may be arranged in a hierarchy and may include one or more levels of cache. Memory may be volatile (such as random access memory (RAM)), non-volatile (such as read only memory (ROM), flash memory, etc.) or some combination of the two. The computing device can take one or more of several forms. Such forms include a tablet, a personal computer, a workstation, a server, a handheld device, a consumer electronic device, or other, and can be a stand-alone device or configured as part of a computer network, computer cluster, cloud services infrastructure, or other. Computing device may also include additional storage. Storage may be removable and/or non-removable and can include magnetic or optical disks or solid-state memory, or flash storage devices. Computer storage media includes Volatile and non-volatile, removable and non-removable media implemented in any suitable method or technology for storage of information Such as computer readable instructions, data structures, program modules or other data. A propagating signal by itself does not qualify as storage media. Computing device often includes one or more input and/or output connections, such as USB connections, display ports, proprietary connections, and other to connect various devices such as keyboard, pointing device (e.g., mouse), pen, voice input device (e.g. microphone), video camera, touch input device, or other. Output devices may include devices such as a display, speakers, printer, or the like. Computing device often includes one or more communication connections that allow computing device to communicate with other computers/applications. Example communication connections can include, but are not limited to, an Ethernet interface, a wireless interface, a bus interface, a storage area network interface, a proprietary interface. The communication connections can be used to couple the computing device to a computer network, which is a computing devices and possibly other devices interconnected by communications channels that facilitate communications and allows sharing of resources and information among interconnected devices. Examples of computer networks include a local area network, a wide area network, the Internet, or other network. Special purpose media delivery computer systems are optimized for storage and delivery of respective media content, such as video, audio, graphics, virtual reality, augmented reality, and text. Computing device can be configured to run an operating system Software program and one or more computer Software applications, which make up a system platform. A computer Software application configured to execute on the computing device is typically provided as a set of instructions written in a programming language, implementing methods of this disclosure, such 4500, 4600, etc. A computer application configured to execute on the computing device includes at least one computing process (or computing task), which is an executing program. Each computing process provides the computing resources to execute the program. Multimedia employment distribution hardware architecture 4200 includes a group of employment core appliances 346.

Group of employment core appliances 346 comprises: a group of relationship core appliances 348; a group of security core appliances 350; a group of video content core appliances 352; a group of audio content core appliances 354; a group of graphics content core appliances 356; a group of text content core appliances 358; a group of virtual reality content core appliances 360; a group of augmented reality content core appliances 360. Example employment core appliances 346 can include a suitable combination of suitable computer Servers. Such as commodity grade servers, mid-range servers, high end servers, high availability servers, cloud based servers, and data center based servers, in-house server, and other suitable servers. Employment core appliances 346 can also be housed in a suitable combination of cloud service providers, data center providers, and in-house servers. Employment core appliances 346 can provide data backup, data archival, data restore capabilities, physical security, network security, and other suitable server services.

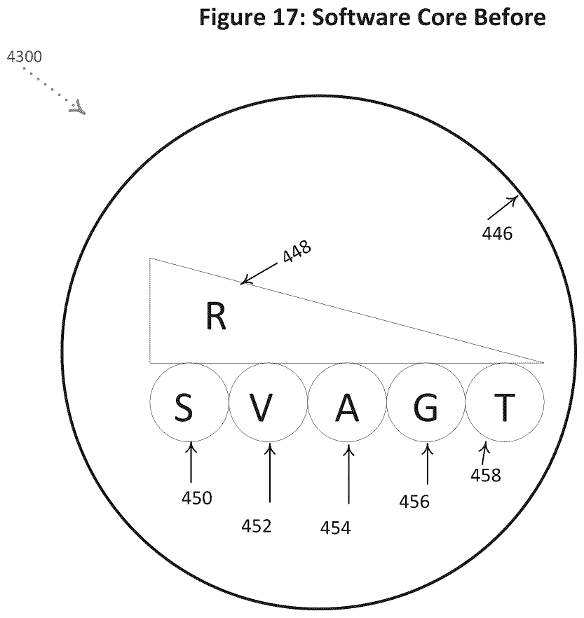

FIG. 17 illustrates an example multimedia employment distribution software architecture 4300 illustrating a software application Solution, which includes a special purpose software components of a multimedia employment distribution system. Multimedia employment distribution software architecture 4300 executes on multimedia employment distribution hardware architecture 4100. Multimedia employment distribution software architecture 4300 includes a group of employment core applications 446.

Group of employment core applications 446 includes integration instructions for controlling communications and represents special purpose media delivery Software applications, which includes delivery instructions for optimal data transfer and protection of data, and comprises: a group of relationship core application Software components 448 (which executes on a group of relationship core appliances 348); a group of security core application Software components 450 (which executes on a group of security core appliances 350); a group of video content core application software components 452 (which executes on a group of video content core appliances 352); a group of audio content core application Software components 454 (which executes on a group of audio content core appliances 354); a group of graphics content core application Software components 456 (which executes on a group of graphics content core appliances 356); and a group of text content core application software components 458 (which executes on a group of text content core appliances 358).

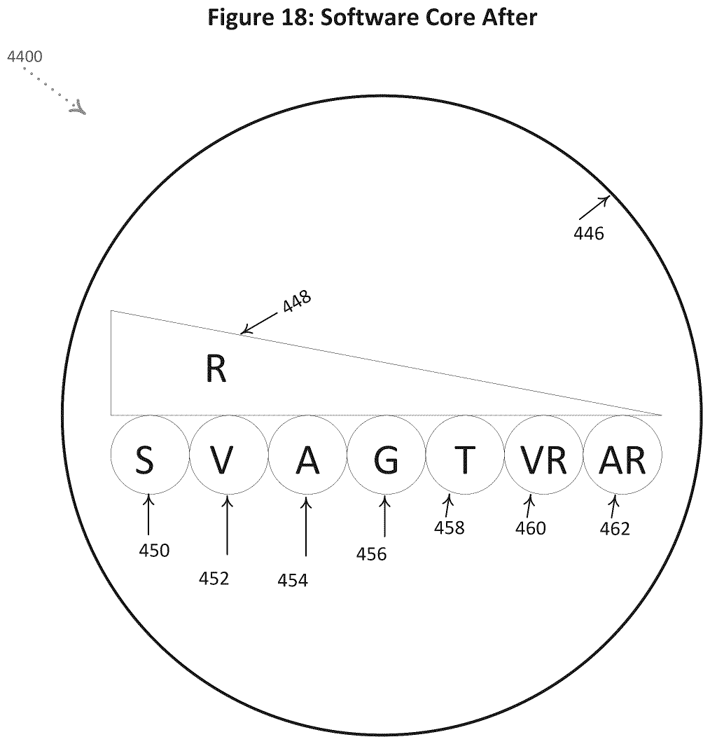

FIG. 18 illustrates an example multimedia employment distribution software architecture 4400 illustrating a software application Solution, which includes a special purpose software components of a multimedia employment distribution system. Multimedia employment distribution software architecture 4400 executes on multimedia employment distribution hardware architecture 4200. Multimedia employment distribution software architecture 4400 includes a group of employment core applications 446.

Group of employment core applications 446 includes integration instructions for controlling communications and represents special purpose media delivery Software applications, which includes delivery instructions for optimal data transfer and protection of data, and comprises: a group of relationship core application Software components 448 (which executes on a group of relationship core appliances 348); a group of security core application Software components 450 (which executes on a group of security core appliances 350); a group of video content core application software components 452 (which executes on a group of video content core appliances 352); a group of audio content core application Software components 454 (which executes on a group of audio content core appliances 354); a group of graphics content core application Software components 456 (which executes on a group of graphics content core appliances 356); and a group of text content core application software components 458 (which executes on a group of text content core appliances 358); and a group of virtual reality content core application software components 460 (which executes on a group of virtual reality content core appliances 360); and a group of augmented reality content core application software components 462 (which executes on a group of augmented reality content core appliances 362).

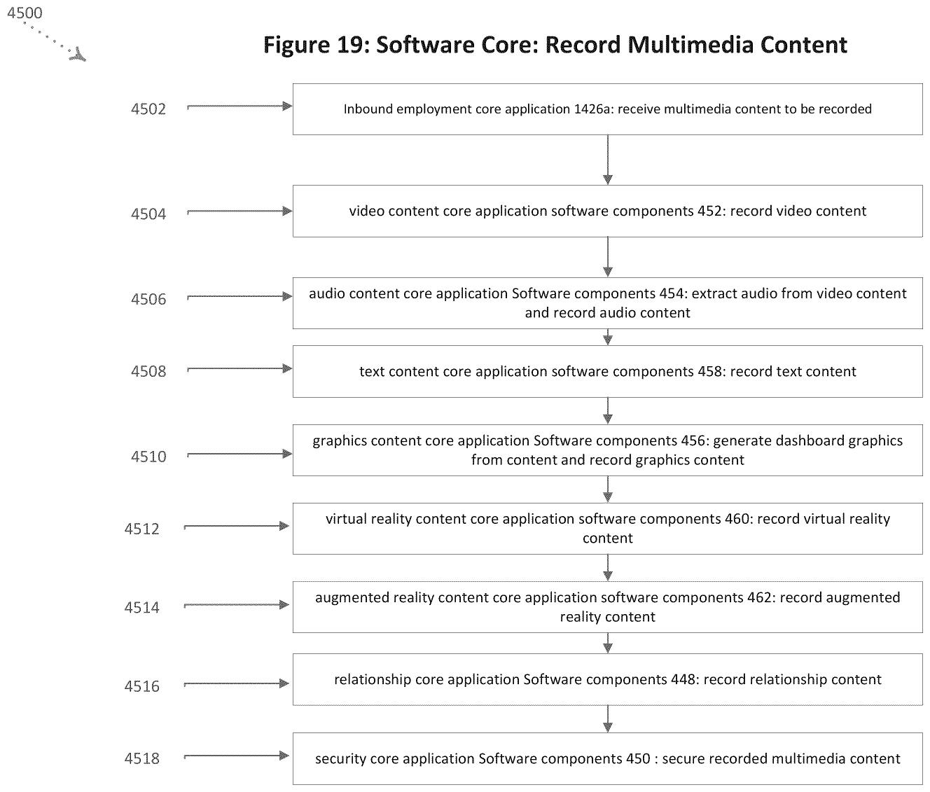

FIG. 19 illustrates an example method 4500 for software core to record multimedia content. Additional steps of this method are illustrated in method 4600 on FIG. 20.

FIG. 20 illustrates an example method 4600 for software core to record multimedia content. This is a continuation of method 4500 on FIG. 19.

It is to be understood that the features of the various exemplary embodiments described herein may be combined with each other, unless specifically noted otherwise.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A multi-tier multimedia employment distribution hub system comprising:
a tier-1 multimedia employment distribution hub including:
a group of tier-1employment hub appliances including processors and memory configured to store and execute a group of tier-1 employment hub applications to:
grant access privilege to the tier-1 multimedia employment distribution hub, the access privilege granted to roles in tier-1 employment client systems, tier-1 employment server systems, and tier-1 employment core systems; and
control the tier-1 employment client systems, the tier-1 employment server systems, and the tier-1 employment core systems.

2. The multi-tier multimedia employment distribution hub system of claim 1 comprising:
a tier-2 multimedia employment distribution hub including:
a group of tier-2 employment hub appliances including processors and memory configured to store and execute a group of tier-2 employment hub applications to:
grant access privilege to the tier-2 multimedia employment distribution hub, the access privilege granted to roles in tier-2 employment client systems, tier-2 employment server systems, and tier-2 employment core systems; and
control the tier-2 employment client systems, the tier-2 employment server systems, and the tier-2 employment core systems.

3. The multi-tier multimedia employment distribution hub system of claim 2 comprising:
a tier-3 multimedia employment distribution hub including:
a group of tier-3 employment hub appliances including processors and memory configured to store and execute a group of tier-3 employment hub applications to:
grant access privilege to the tier-3 multimedia employment distribution hub, the access privilege granted to roles in tier-3 employment client systems, tier-3 employment server systems, and tier-3 employment core systems; and
control the tier-3 employment client systems, the tier-3 employment server systems, and the tier-3 employment core systems.

4. The multi-tier multimedia employment distribution hub system of claim 3 comprising:
a tier-4 multimedia employment distribution hub including:
a group of tier-4 employment hub appliances including processors and memory configured to store and execute a group of tier-4 employment hub applications to:
grant access privilege to the tier-4 multimedia employment distribution hub, the access privilege granted to roles in tier-4 employment client systems, tier-4 employment server systems, and tier-4 employment core systems; and
control the tier-4 employment client systems, the tier-4 employment server systems, and the tier-4 employment core systems.

5. The multi-tier multimedia employment distribution hub system of claim 4 comprising:
a tier-n multimedia employment distribution hub including:
a group of tier-n employment hub appliances including processors and memory configured to store and execute a group of tier-n employment hub applications to:
grant access privilege to the tier-n multimedia employment distribution hub, the access privilege granted to roles in tier-n employment client systems, tier-n employment server systems, and tier-n employment core systems; and
control the tier-n employment client systems, the tier-n employment server systems, and the tier-n employment core systems.

6. A computer readable storage medium storing computer executable instructions for controlling a computing device in a multi-tier multimedia employment distribution hub system to perform a method in the multi-tier multimedia employment distribution hub system, the method comprising:
granting access privilege to a tier-1 multimedia employment distribution hub, the access privilege granted to roles in tier-1 employment client systems, tier-1 employment server systems, and tier-1 employment core systems; and
controlling the tier-1 employment client systems, the tier-1 employment server systems, and the tier-1 employment core systems.

7. The computer readable storage medium of claim 6, the method comprising:
granting access privilege to a tier-2 multimedia employment distribution hub, the access privilege granted to roles in tier-2 employment client systems, tier-2 employment server systems, and tier-2 employment core systems; and
controlling the tier-2 employment client systems, the tier-2 employment server systems, and the tier-2 employment core systems.

8. The computer readable storage medium of claim 7, the method comprising:
granting access privilege to a tier-3 multimedia employment distribution hub, the access privilege granted to roles in tier-3 employment client systems, tier-3 employment server systems, and tier-3 employment core systems; and
controlling the tier-3 employment client systems, the tier-3 employment server systems, and the tier-3 employment core systems.

9. The computer readable storage medium of claim 8, the method comprising:
granting access privilege to a tier-4 multimedia employment distribution hub, the access privilege granted to roles in tier-4 employment client systems, tier-4 employment server systems, and tier-4 employment core systems; and
controlling the tier-4 employment client systems, the tier-4 employment server systems, and the tier-4 employment core systems.

10. The computer readable storage medium of claim 9, the method comprising:
granting access privilege to a tier-n multimedia employment distribution hub, the access privilege granted to roles in tier-n employment client systems, tier-n employment server systems, and tier-n employment core systems; and
controlling the tier-n employment client systems, the tier-n employment server systems, and the tier-n employment core systems.

11. A multi-tier multimedia employment distribution hub system computing device implemented method comprising:
granting access privilege to a tier-1 multimedia employment distribution hub, the access privilege granted to roles in tier-1 employment client systems, tier-1 employment server systems, and tier-1 employment core systems; and
controlling the tier-1 employment client systems, the tier-1 employment server systems, and the tier-1 employment core systems.

12. The multi-tier multimedia employment distribution hub system computing device implemented method of claim 11 comprising:
granting access privilege to a tier-2 multimedia employment distribution hub, the access privilege granted to roles in tier-2 employment client systems, tier-2 employment server systems, and tier-2 employment core systems; and
controlling the tier-2 employment client systems, the tier-2 employment server systems, and the tier-2 employment core systems.

13. The multi-tier multimedia employment distribution hub system computing device implemented method of claim 12 comprising:
granting access privilege to a tier-3 multimedia employment distribution hub, the access privilege granted to roles in tier-3 employment client systems, tier-3 employment server systems, and tier-3 employment core systems; and
controlling the tier-3 employment client systems, the tier-3 employment server systems, and the tier-3 employment core systems.

14. The multi-tier multimedia employment distribution hub system computing device implemented method of claim 13 comprising:
granting access privilege to a tier-4 multimedia employment distribution hub, the access privilege granted to roles in tier-4 employment client systems, tier-4 employment server systems, and tier-4 employment core systems; and
controlling the tier-4 employment client systems, the tier-4 employment server systems, and the tier-4 employment core systems.

15. The multi-tier multimedia employment distribution hub system computing device implemented method of claim 14 comprising:
granting access privilege to a tier-n multimedia employment distribution hub, the access privilege granted to roles in tier-n employment client systems, tier-n employment server systems, and tier-n employment core systems; and
controlling the tier-n employment client systems, the tier-n employment server systems, and the tier-n employment core systems.
